(19) United States
(12) Patent Application Publication
(10) Pub. No.: US 2008/0320149 A1
(43) Pub. Date: Dec. 25, 2008

(54) SERVICE REQUEST DEVICE WIRELESS ACCESS DETACH AND BEARER DEACTIVATION METHODS WITHOU LOSS OF INTERNET PROTOCOL CONNECTIVITY

(76) Inventor: Stefano Faccin, Fremont, CA (US)

Correspondence Address: HARNESS, DICKEY & PIERCE P.L.C., 5445 CORPORATE DRIVE, SUITE 200, TROY, MI, 48098, US

(21) Appl. No.: 12/137,805

(22) Filed: Jun. 12, 2008

Related U.S. Application Data
(60) Provisional application No. 60/946,035, filed on Jun. 25, 2007.

(51) Int. Cl. G06F 15/16

(52) U.S. Cl. 709/228

(57) ABSTRACT

A network device includes an Internet protocol (IP) connectivity generator that generates an IP connectivity indicator. The IP connectivity indicator indicates IP connectivity for a service request device (SRD). A transmit module transmits the IP connectivity indicator to a remote network device before at least one of detachment of the SRD and deactivation of a bearer corresponding to a first session and a tunnel between the SRD and the remote network device. A control module facilitates the detachment of the SRD and deactivation of the bearer while maintaining IP connectivity. The IP connectivity corresponding to at least one of attachment of the SRD and activation of a second session of the SRD based on the IP connectivity indicator.

### CROSS-REFERENCE TO RELATED APPLICATIONS

This application claims the benefit of U.S. Provisional Application No. 60/946,035, filed on Jun. 25, 2007. The disclosures of the above applications are incorporated herein by reference in their entirety.

### FIELD

The subject matter of this patent application relates to communication systems, and more particularly to protocols for managing connectivity, detachment, and bearer deactivation corresponding to service request devices.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In the standardization of evolved 3^{rd} Generation Partnership Project (3GPP™) networks, 3GPP™ system architecture evolution (SAE) work is defining a new architecture where both evolved 3GPP™ wireless access (LTE—Long Term Evolution access) and non-3GPP™ accesses are considered. The technical specification (TS) 23.401 “3GPP™ GPRS enhancements for LTE access” [1] and the TS 23.402 “3GPP™ Architecture enhancements for non-3GPP™ accesses” [2], which are incorporated herein by reference in their entirety, contain the current definitions for the architecture and related mechanisms. Specifically, [1] covers one possible implementation of the SAE network supporting LTE, and [2] describes an alternative that supports both LTE and non-3GPP™ accesses. 3GPP™ requires an evolved 3GPP™ system to provide enhanced performance (e.g., low communication delay, low connection set-up time and high communication quality).

Traditionally in cellular networks (e.g., 3GPP™ evolved packet system (EPS)), a service request device (SRD) (e.g., a mobile network device) attaches to a network—for example, the SRD registers with the network to receive IP services associated with the network. This registration is commonly referred to as network attachment. After network attachment and authentication, connectivity corresponding to the SRD is setup. This connectivity may include IP connectivity, which allows for the reception of IP services with predetermined quality of service levels.

To prevent delays, a default EPS bearer or default system architecture evolution (SAE) bearer is defined by the 3GPP™ for both 3GPP™ access and non-3GPP™ access. For example, [1] states that a default SAE bearer is established during network attachment by an SRD to enable an “always-on IP connectivity” for an SRD with respect to a particular packet data network (PDN). This default has been introduced in order to simplify and speed up the connectivity with that packet data network. The always-on IP connectivity remains established while the SRD is connected to the packet data network.

During network attachment, one or more bearer establishment procedures may be triggered to establish EPS bearers for the SRD. A bearer may refer to a set of addresses that define a “pipe” or “tunnel” for an Internet session between the SRD and a packet data network. IP services are provided via the PDN. A bearer may be associated with a specific type of packets that are provided over the setup IP connectivity and correspond with specific IP services.

A visited public land mobile network (VPLMN) or a home PLMN (HPLMN) may select a network connectivity domain for the SRD and select services that the SRD obtains access to through the default SAE bearer. The network connectivity domain includes the selection of a packet data network and a packet data network SAE gateway. The SRD can gain IP connectivity via the packet data network and the packet data network SAE gateway. The VPLMN and/or the HPLMN may randomly provide this selection or may base the selection on, for example, network policies configured by a network operator (e.g. T-mobile™) or a SRD profile. The selections are referred to as default selections.

Access to different packet data networks (e.g., 3GPP™ operator core services, enterprise connectivity, etc.) may require the selection of a different packet data network SAE gateway then selected. To access a new (different) packet data network, the SRD needs to request a new SAE bearer, which may refer to a set of addresses for an Internet session between the SRD and the new packet data network. The SRD provides information that identifies the new packet data network. This request introduces a delay, similar to the delay associated with the non-setup of a default bearer in which, for example, a network connectivity domain must be determined before IP services can be received. A different packet data network may be requested due to a difference in user requirements and/or application requirements and services provided by the selected connectivity domain. A different packet data network may also be requested when the user of the SRD uses a terminal with different capabilities than a terminal that the HPLMN has associated with a stored profile of the user.

When the SRD travels or switches between a 3GPP™ network and a non-3GPP™ network and/or when switching between different packet data networks, EPS bearer(s) for the SRD are typically deactivated. This deactivation includes the disconnection of IP connectivity. To establish IP connectivity with the same packet data network or with a different packet data network from the non-3GPP™ network, IP connectivity must therefore again be setup.

### SUMMARY

In one embodiment, a network device is provided and includes an Internet protocol (IP) connectivity generator that generates an IP connectivity indicator. The IP connectivity indicator indicates IP connectivity for a service request device (SRD). A transmit module transmits the IP connectivity indicator to a remote network device before at least one of detachment of the SRD and deactivation of a bearer corresponding to a first session and a tunnel between the SRD and the remote network device. A control module facilitates the detachment of the SRD and deactivation of the bearer while maintaining IP connectivity. The IP connectivity corresponds to the attachment of the SRD and activation of a second session of the SRD based on the IP connectivity indicator.

In other features, the bearer includes a set of addresses corresponding to the first session and associated with communication between the SRD and a packet data network. In other features, the control module facilitates the attachment of the SRD and activation of the second session based on maintenance of the IP connectivity. In other features, the control module initiates the attachment of the SRD and activation of the second session.

In other features, the detachment includes detachment from a first network. The control module facilitates attachment of the SRD to a second network. In other features, the first network includes at least one of a radio access network and a servicing general packet radio service support node. In other features, the first network includes a cellular network and the second network includes wireless local area network.

In other features, the detachment includes detachment from a first network device of a network. The control module attaches the SRD to a second network device of the network. In other features, the first session and the second session are with at least one of the same network and gateway.

In other features, the first session and the second session are with at least one of the same packet data network and packet data network gateway. In other features, the first session includes communication via a tunnel of a first network and the second session includes communication via a tunnel of a second network that is different than the first network. In other features, the first network includes a cellular network and the second network includes wireless local area network.

In other features, the first session includes communication via a first tunnel of a first network and the second session includes communication via a second tunnel between the first network and a second network that is different than the first network. In other features, the SRD includes the network device.

In other features, IP connectivity of the SRD is maintained during at least one of detachment of the SRD and deactivation of the bearer based on the IP connectivity indicator. In other features, the IP connectivity is maintained between the SRD and a packet data network.

In other features, connectivity of the SRD is maintained with a network. IP connectivity corresponding to the attachment of the SRD and activation of the second session is not maintained when the bearer is deactivated based on the IP connectivity indicator.

In other features, the SRD includes the network device. The control module at least one of initiates and triggers the detachment of the SRD and deactivation of the bearer.

In other features. The network device of claim 18, the control module triggers the detachment of the SRD and deactivation of the bearer by generating a deactivate bearer request signal that includes the IP connectivity indicator, and the remote network device initiates the detachment of the SRD and deactivation of the bearer by generating a delete dedicated bearer request signal based on the deactivate bearer request signal.

In other features, the network device further includes a receive module. The transmit module transmits a detach request signal including the IP connectivity indicator to the remote network device. The receive module receives a detach accept signal based on the detach request signal.

In other features, the network device further includes a receive module. The transmit module transmits a deactivate bearer request signal including the IP connectivity indicator to the remote network device. The receive module receives a deactivate accept signal based on the deactivate bearer request signal.

In other features, the network device further includes a receive module. The transmit module transmits a deactivate request signal including the IP connectivity indicator to the remote network device. The receive module receives a bearer release request signal based on the deactivate request signal. The transmit module transmits to the remote network device a bearer release response signal based on the bearer release request signal.

In other features, the network device further includes a receive module. The control module generates a deactivate bearer request signal that includes the IP connectivity indicator. The receive module receives a bearer release request signal from the remote network device based on the deactivate bearer request signal. The control module removes uplink traffic flow templates corresponding to the bearer.

In other features, the network device further includes a receive module. The transmit module transmits a cancel location signal including the IP connectivity indicator to the remote network device. The receive module receives a delete bearer signal based on the cancel location signal.

In other features, a system is provided that includes the network device. The control module initiates the detachment of the SRD and deactivation of the bearer. The system includes one of a mobility management entity, a serving gateway, a PDN gateway, or a server.

In other features, a network is provided and includes the network device and further includes the remote network device. The remote network device receives the IP connectivity indicator and proceeds to at least one of detach the SRD and deactivate the bearer while maintaining IP connectivity of the SRD based on the IP connectivity indicator.

In other features, a network device is provided and includes a receive module that receives an IP connectivity indicator. The IP connectivity indicator indicates IP connectivity for a SRD from a remote network device. The IP connectivity indicator is received before at least one of detachment of the SRD and deactivation of a bearer corresponding to a first session and a tunnel between the SRD and the remote network device. A control module maintains IP connectivity corresponding to at least one of attachment of the SRD and activation of a second session of the SRD based on the IP connectivity indicator.

In other features, the bearer includes a set of addresses corresponding to the first session and associated with communication between the SRD and a packet data network. In other features, the control module facilitates the attachment of the SRD and activation of the second session based on maintenance of the IP connectivity.

In other features, the receive module receives a detach request signal that includes the IP connectivity indicator. The control module generates at least one of a delete bearer signal and a bearer acknowledgement signal based on the detach request signal.

In other features, the receive module receives a delete bearer signal based on a detach request signal that includes the IP connectivity indicator. The control module generates a bearer acknowledgement signal based on the delete bearer signal.

In other features, the receive module receives a deactivate request signal that includes the IP connectivity indicator. The control module generates at least one of a delete bearer request signal and a delete bearer acknowledgement signal based on the deactivate request signal.

In other features, the receive module receives a delete bearer request signal that includes the IP connectivity indicator. The control module generates a delete bearer acknowledgement signal based on the delete bearer request signal.

In other features, the network device further includes a transmit module that transmits a delete bearer request signal based on the IP connectivity indicator. The receive module receives a delete bearer response signal from the remote network device based on the delete bearer request signal.

In other features, the detachment includes detachment from a first network. The control module facilitates attachment of the SRD to a second network. In other features, the first network includes at least one of a radio access network and a servicing general packet radio service support node.

In other features, the first network includes a cellular network and the second network includes wireless local area network. In other features, the detachment includes detachment from a first network device of a network. The control module attaches the SRD to a second network device of the network.

In other features, the first session and the second session are with at least one of the same network and gateway. In other features, the first session and the second session are with at least one of the same packet data network and packet data network gateway.

In other features, the first session includes communication via a tunnel of a first network and the second session includes communication via a tunnel of a second network that is different than the first network. In other features, the first network includes a cellular network and the second network includes wireless local area network.

In other features, the first session includes communication via a first tunnel of a first network and the second session includes communication via a second tunnel of the first network and a second network that is different than the first network. In other features, the SRD includes the network device.

In other features, IP connectivity of the SRD is maintained during the detachment of the SRD and deactivation of the bearer based on the IP connectivity indicator. In other features, the IP connectivity is maintained between the SRD and a packet data network.

In other features, connectivity of the SRD is maintained with a network. The IP connectivity corresponding to the attachment of the SRD and activation of the second session is not maintained when the bearer is deactivated based on the IP connectivity indicator.

In other features, the SRD includes the network device. The control module at least one of initiates and triggers the detachment of the SRD and deactivation of the bearer. In other features, the control module triggers the detachment of the SRD and deactivation of the bearer by generation of a deactivate bearer request signal that includes the IP connectivity indicator. The remote network device initiates the detachment of the SRD and deactivation of the bearer by generating a delete dedicated bearer request signal based on the deactivate bearer request signal.

In other features, a system is provided and includes the network device. The control module initiates the detachment of the SRD and deactivation of the bearer. The system includes one of a serving gateway, a PDN gateway, or a server. In other features, a network is provided and includes the network device and further includes the remote network device. The remote network device receives the IP connectivity indicator and proceeds to at least one of detach the SRD and deactivate the bearer while maintaining IP connectivity of the SRD based on the IP connectivity indicator.

In other features, a method of operating a network device is provided and includes generating an IP connectivity indicator that indicates IP connectivity for a SRD. The IP connectivity indicator is transmitted to a remote network device before at least one of detachment of the SRD and deactivation of a bearer corresponding to a first session and a tunnel between the SRD and the remote network device. The detachment of the SRD and deactivation of the bearer are facilitated while maintaining IP connectivity. The IP connectivity corresponds to at least one of attachment of the SRD and activation of a second session of the SRD based on the IP connectivity indicator.

In other features, the bearer includes a set of addresses corresponding to the first session and associated with communication between the SRD and a packet data network. In other features, the method includes facilitating the attachment of the SRD and activation of the second session based on maintenance of the IP connectivity.

In other features, the method further includes initiating the attachment of the SRD and activation of the second session. In other features, the method further includes facilitating attachment of the SRD to a second network. The detachment includes detachment from a first network. In other features, the first network includes at least one of a radio access network and a servicing general packet radio service support node. In other features, the first network includes a cellular network and the second network includes wireless local area network.

In other features, the method further includes attaching the SRD to a second network device of the network. The detachment includes detachment from a first network device of a network. In other features, the first session and the second session are with at least one of the same network and gateway.

In other features, the first session and the second session are with at least one of the same packet data network and packet data network gateway. In other features, the first session includes communication via a tunnel of a first network and the second session includes communication via a tunnel of a second network that is different than the first network. In other features, the first network includes a cellular network and the second network includes wireless local area network.

In other features, the first session includes communication via a first tunnel of a first network and the second session includes communication via a second tunnel between the first network and a second network that is different than the first network. In other features, the SRD includes the network device.

In other features, IP connectivity of the SRD is maintained during the detachment of the SRD and deactivation of the bearer based on the IP connectivity indicator. In other features, the IP connectivity is maintained between the SRD and a packet data network.

In other features, connectivity of the SRD is maintained with a network. The IP connectivity corresponding to the attachment of the SRD and activation of the second session is not maintained when the bearer is deactivated based on the IP connectivity indicator.

In other features, the method further includes at least one of initiating and triggering the detachment of the SRD and deactivation of the bearer. The SRD includes the network device. In other features, the method further includes triggering the detachment of the SRD and deactivation of the bearer by generating a deactivate bearer request signal. The deactivate bearer request signal includes the IP connectivity indicator. The detachment of the SRD and deactivation of the bearer are initiated via the remote network device by generating a delete dedicated bearer request signal based on the deactivate bearer request signal.

In other features, the method further includes transmitting a detach request signal including the IP connectivity indicator to the remote network device. A detach accept signal is received based on the detach request signal.

In other features, the method further includes transmitting a deactivate bearer request signal including the IP connectivity indicator to the remote network device. A deactivate accept signal is received based on the deactivate bearer request signal.

In other features, the method further includes transmitting a deactivate request signal including the IP connectivity indicator to the remote network device. A bearer release request signal is received based on the deactivate request signal. A bearer release response signal is transmitted to the remote network device based on the bearer release request signal.

In other features, the method further includes generating a deactivate bearer request signal that includes the IP connectivity indicator. A bearer release request signal is received from the remote network device based on the deactivate bearer request signal. Uplink traffic flow templates corresponding to the bearer are removed.

In other features, the method further includes transmitting a cancel location signal including the IP connectivity indicator to the remote network device. A delete bearer signal is received based on the cancel location signal.

In other features, the method further includes receiving the IP connectivity indicator via the remote network device and proceeding to at least one of detaching the SRD and deactivating the bearer while maintaining IP connectivity of the SRD. The IP connectivity is maintained based on the IP connectivity indicator.

In other features, a method of operating a network device is provided and includes receiving an IP connectivity indicator. The IP connectivity indicator indicates IP connectivity for a SRD from a remote network device. The IP connectivity indicator is received before at least one of detachment of the SRD and deactivation of a bearer corresponding to a first session and a tunnel between the SRD and the remote network device. IP connectivity corresponding to at least one of attachment of the SRD and activation of a second session of the SRD is maintained based on the IP connectivity indicator.

In other features, the bearer includes a set of addresses corresponding to the first session and associated with communication between the SRD and a packet data network. In other features, the method includes facilitating the attachment of the SRD and activation of the second session based on maintenance of the IP connectivity.

In other features, the method further includes receiving a detach request signal that includes the IP connectivity indicator. At least one of a delete bearer signal and a bearer acknowledgement signal is generated based on the detach request signal.

In other features, the method further includes receiving a delete bearer signal based on a detach request signal that includes the IP connectivity indicator. A bearer acknowledgement signal is generated based on the delete bearer signal.

In other features, the method further includes receiving a deactivate request signal that includes the IP connectivity indicator. At least one of a delete bearer request signal and a delete bearer acknowledgement signal is generated based on the deactivate request signal.

In other features, the method further includes receiving a delete bearer request signal that includes the IP connectivity indicator. A delete bearer acknowledgement signal is generated based on the delete bearer request signal.

In other features, the method further includes transmitting a delete bearer request signal based on the IP connectivity indicator. A delete bearer response signal is received from the remote network device based on the delete bearer request signal.

In other features, the method further includes facilitating attachment of the SRD to a second network. The detachment includes detachment from a first network. In other features, the first network includes at least one of a radio access network and a servicing general packet radio service support node. In other features, the first network includes a cellular network and the second network includes wireless local area network.

In other features, the method further includes attaching the SRD to a second network device of the network. The detachment includes detachment from a first network device of a network. In other features, the first session and the second session are with at least one of the same network and gateway. In other features, the first session and the second session are with at least one of the same packet data network and packet data network gateway.

In other features, the first session includes communication via a tunnel of a first network and the second session includes communication via a tunnel of a second network that is different than the first network. In other features, the first network includes a cellular network and the second network includes wireless local area network.

In other features, the first session includes communication via a first tunnel of a first network and the second session includes communication via a second tunnel of the first network and a second network that is different than the first network. In other features, the SRD includes the network device.

In other features, IP connectivity of the SRD is maintained during the detachment of the SRD and deactivation of the bearer based on the IP connectivity indicator. In other features, the IP connectivity is maintained between the SRD and a packet data network.

In other features, connectivity of the SRD is maintained with a network. The IP connectivity corresponding to the attachment of the SRD and activation of the second session is not maintained when the bearer is deactivated based on the IP connectivity indicator. In other features, the method further includes at least one of initiating and triggering the detachment of the SRD and deactivation of the bearer. The SRD includes the network device.

In other features, the method further includes triggering the detachment of the SRD and deactivation of the bearer by generation of a deactivate bearer request signal that includes the IP connectivity indicator. The detachment of the SRD and deactivation of the bearer are initiated by generating a delete dedicated bearer request signal based on the deactivate bearer request signal.

In other features, the method further includes receiving the IP connectivity indicator via the remote network device and proceeding to at least one of detaching the SRD and deactivating the bearer while maintaining IP connectivity of the SRD. The IP connectivity is maintained based on the IP connectivity indicator.

In other features, a network device is provided and includes IP connectivity generating means for generating an IP connectivity indicator. The IP connectivity indicator indicates IP connectivity for a SRD. Transmit means transmits the IP connectivity indicator to a remote network device before at least one of detachment of the SRD and deactivation of a bearer corresponding to a first session and a tunnel between the SRD and the remote network device. Control means facilitates the detachment of the SRD and deactivation of the bearer while maintaining IP connectivity. The IP connectivity corresponds to at least one of attachment of the SRD and activation of a second session of the SRD based on the IP connectivity indicator.

In other features, the bearer includes a set of addresses corresponding to the first session and associated with communication between the SRD and a packet data network.

In other features, the control means facilitates the attachment of the SRD and activation of the second session based on maintenance of the IP connectivity. In other features, the control means initiates the attachment of the SRD and activation of the second session.

In other features, the detachment includes detachment from a first network. The control means facilitates attachment of the SRD to a second network. In other features, the first network includes at least one of a radio access network and a servicing general packet radio service support node. In other features, the first network includes a cellular network and the second network includes wireless local area network.

In other features, the detachment includes detachment from a first network device of a network, and the control means attaches the SRD to a second network device of the network. In other features, the first session and the second session are with at least one of the same network and gateway.

In other features, the first session and the second session are with at least one of the same packet data network and packet data network gateway. In other features, the first session includes communication via a tunnel of a first network and the second session includes communication via a tunnel of a second network that is different than the first network. In other features, the first network includes a cellular network and the second network includes wireless local area network.

In other features, the first session includes communication via a first tunnel of a first network and the second session includes communication via a second tunnel between the first network and a second network that is different than the first network. In other features, the SRD includes the network device.

In other features, IP connectivity of the SRD is maintained during the detachment of the SRD and deactivation of the bearer based on the IP connectivity indicator. In other features, the IP connectivity is maintained between the SRD and a packet data network.

In other features, connectivity of the SRD is maintained with a network and the IP connectivity corresponding to the attachment of the SRD and activation of the second session is not maintained when the bearer is deactivated based on the IP connectivity indicator. In other features, the SRD includes the network device. The control means at least one of initiates and triggers the detachment of the SRD and deactivation of the bearer.

In other features, the control means triggers the detachment of the SRD and deactivation of the bearer by generating a deactivate bearer request signal that includes the IP connectivity indicator. The remote network device initiates the detachment of the SRD and deactivation of the bearer by generating a delete dedicated bearer request signal based on the deactivate bearer request signal.

In other features, the network device further includes receiving means for receiving. The transmit means transmits a detach request signal including the IP connectivity indicator to the remote network device. The receive means receives a detach accept signal based on the detach request signal.

In other features, the network device further includes receiving means for receiving. The transmit means transmits a deactivate bearer request signal including the IP connectivity indicator to the remote network device. The receive means receives a deactivate accept signal based on the deactivate bearer request signal.

In other features, the network device further includes receiving means for receiving. The transmit means transmits a deactivate request signal including the IP connectivity indicator to the remote network device. The receive means receives a bearer release request signal based on the deactivate request signal. The transmit means transmits to the remote network device a bearer release response signal based on the bearer release request signal.

In other features, the network device further includes receiving means for receiving. The control means generates a deactivate bearer request signal that includes the IP connectivity indicator. The receive means receives a bearer release request signal from the remote network device based on the deactivate bearer request signal. The control means removes uplink traffic flow templates corresponding to the bearer.

In other features, the network device further includes receiving means for receiving. The transmit means transmits a cancel location signal including the IP connectivity indicator to the remote network device. The receive means receives a delete bearer signal based on the cancel location signal.

In other features, a system is provided and includes the network device. The control means initiates the detachment of the SRD and deactivation of the bearer. The system includes one of a mobility management entity, a serving gateway, a PDN gateway, or a server.

In other features, a network is provided and includes the network device and further includes the remote network device. The remote network device receives the IP connectivity indicator and proceeds to at least one of detach the SRD and deactivate the bearer while maintaining IP connectivity of the SRD based on the IP connectivity indicator.

In other features, a network device is provided and includes receiving means for receiving an IP connectivity indicator. The IP connectivity indicator indicates IP connectivity for a SRD from a remote network device. The IP connectivity indicator is received before at least one of detachment of the SRD and deactivation of a bearer corresponding to a first session and a tunnel between the SRD and the remote network device. Control means maintains IP connectivity corresponding to at least one of attachment of the SRD and activation of a second session of the SRD based on the IP connectivity indicator.

In other features, the bearer includes a set of addresses corresponding to the first session and associated with communication between the SRD and a packet data network. In other features, the control means facilitates the attachment of the SRD and activation of the second session based on maintenance of the IP connectivity.

In other features, the receive means receives a detach request signal that includes the IP connectivity indicator. The control means generates at least one of a delete bearer signal and a bearer acknowledgement signal based on the detach request signal.

In other features, the receive means receives a delete bearer signal based on a detach request signal that includes the IP connectivity indicator. The control means generates a bearer acknowledgement signal based on the delete bearer signal.

In other features, the receive means receives a deactivate request signal that includes the IP connectivity indicator. The control means generates at least one of a delete bearer request signal and a delete bearer acknowledgement signal based on the deactivate request signal.

In other features, the receive means receives a delete bearer request signal that includes the IP connectivity indicator. The control means generates a delete bearer acknowledgement signal based on the delete bearer request signal.

In other features, the network device further includes transmitting means for transmitting a delete bearer request signal based on the IP connectivity indicator. The receive means receives a delete bearer response signal from the remote network device based on the delete bearer request signal.

In other features, the detachment includes detachment from a first network. The control means facilitates attachment of the SRD to a second network. In other features, the first network includes at least one of a radio access network and a servicing general packet radio service support node. In other features, the first network includes a cellular network and the second network includes wireless local area network.

In other features, the detachment includes detachment from a first network device of a network. The control means attaches the SRD to a second network device of the network. In other features, the first session and the second session are with at least one of the same network and gateway.

In other features, the first session and the second session are with at least one of the same packet data network and packet data network gateway. In other features, the first session includes communication via a tunnel of a first network and the second session includes communication via a tunnel of a second network that is different than the first network. In other features, the first network includes a cellular network and the second network includes wireless local area network.

In other features, the first session includes communication via a first tunnel of a first network and the second session includes communication via a second tunnel of the first network and a second network that is different than the first network. In other features, the SRD includes the network device.

In other features, IP connectivity of the SRD is maintained during the detachment of the SRD and deactivation of the bearer based on the IP connectivity indicator. In other features, the IP connectivity is maintained between the SRD and a packet data network.

In other features, connectivity of the SRD is maintained with a network. The IP connectivity corresponding to the attachment of the SRD and activation of the second session is not maintained when the bearer is deactivated based on the IP connectivity indicator.

In other features, the SRD includes the network device. The control means at least one of initiates and triggers the detachment of the SRD and deactivation of the bearer. In other features, the control means triggers the detachment of the SRD and deactivation of the bearer by generation of a deactivate bearer request signal that includes the IP connectivity indicator. The remote network device initiates the detachment of the SRD and deactivation of the bearer by generating a delete dedicated bearer request signal based on the deactivate bearer request signal.

In other features, a system is provided and includes the network device. The control means initiates the detachment of the SRD and deactivation of the bearer. The system includes one of a serving gateway, a PDN gateway, or a server.

In other features, a network is provided and includes the network device and further includes the remote network device. The remote network device receives the IP connectivity indicator and proceeds to at least one of detach the SRD and deactivate the bearer while maintaining IP connectivity of the SRD. The IP connectivity is maintained based on the IP connectivity indicator.

In still other features, the systems and methods described above are implemented by a computer program executed by one or more processors. The computer program can reside on a computer readable medium such as but not limited to memory, non-volatile data storage and/or other suitable tangible storage mediums.

Further areas of applicability of the present disclosure will become apparent from the detailed description provided hereinafter. It should be understood that the detailed description and specific examples, while indicating various embodiments of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a message flow diagram illustrating a conventional method of managing deactivation of a dedicated bearer in an evolved packet system;

FIG. 2 a message flow diagram illustrating a conventional method of managing detachment of user equipment in a general packet radio service environment;

FIG. 3 is a functional block diagram of an exemplary network system;

FIG. 4 is a functional block diagram of an exemplary network system illustrating non-roaming access;

FIG. 5 is a functional block diagram of an exemplary network system illustrating roaming access;

FIG. 6 is a functional block diagram of another exemplary network system;

FIG. 7 is a functional block diagram of another exemplary network system;

FIG. 8 is a message flow diagram illustrating a method of managing detachment when initiated by a service request device;

FIG. 9 is a message flow diagram illustrating an exemplary method of managing bearer deactivation when initiated and determined by a service request device;

FIG. 10 is a message flow diagram illustrating an exemplary method of managing bearer deactivation when triggered by a service request device and determined by a packet data network gateway;

FIG. 11 is a message flow diagram illustrating an exemplary method of managing detachment initiated by a home subscriber server;

FIG. 12 is a logic flow diagram illustrating an exemplary method of performing attachment and activation transfer;

FIG. 13 is a block diagram of an exemplary IP descriptor;

FIG. 14 is a block diagram of an exemplary fully qualified domain name;

FIG. 15 is a block diagram of an exemplary fully qualified domain name;

FIG. 16A is a functional block diagram of a high definition television;

FIG. 16B is a functional block diagram of a vehicle control system;

FIG. 16C is a functional block diagram of a cellular phone;

FIG. 16D is a functional block diagram of a set top box; and

FIG. 16E is a functional block diagram of a mobile device.

### DETAILED DESCRIPTION

In the following description, a bearer defines a set(s) of functions and protocols that are used to communicate a data packet between two endpoints. When a data packet is transmitted from a mobile terminal to a network or vice versa over a set of interfaces (either wireless, wired, or a combination of both wireless and wired), the set of protocols, interfaces, and nodes and associated functionality that transports the data packet between the two endpoints is defined as a bearer (or a data bearer). A bearer may refer to a set of addresses, frequencies, channels, preambles, etc. that are associated with the communications between the two endpoints.

Various different types of bearers may be setup for wireless and/or wired communications. For example, when user equipment (UE) connects to a packet data network (PDN), an evolved packet system (EPS) bearer is established. The EPS bearer may identify a service data flow (SDF) aggregate between a UE and a PDN GW or between UE and serving GW. An EPS bearer refers to the level of granularity for bearer level quality of service control. See 3GPP™ TS 23.401 (General Packet Radio Service Enhancements for Evolved Universal Terrestrial Radio Access Network E-UTRAN Access, which is incorporated herein by reference in their entirety.

The EPS bearer may be referred to as a default bearer. A default bearer may be setup when UE connects to a network. A default bearer may have an associated quality of service (QofS) level. The same QofS level may be provided for each default bearer of multiple services. For example, the same QofS level may be associated with the default bearers for voice over Internet phone (VoIP), Internet browsing, etc.

An EPS bearer is referred to as a guaranteed bit rate (GBR) bearer when dedicated network resources related to a GBR value that is associated with the EPS bearer are allocated at bearer establishment. Otherwise, an EPS bearer may be referred to as a non-GBR bearer.

As another example, additional bearers that are established between the UE and the same PDN may be referred to as dedicated bearers. Dedicated bearers for different services may have a different associated QofS level. For example, VoIP may have a higher QofS level than Internet browsing. A dedicated bearer may be a GBR bearer or a non-GBR bearer. A default bearer is a non-GBR bearer.

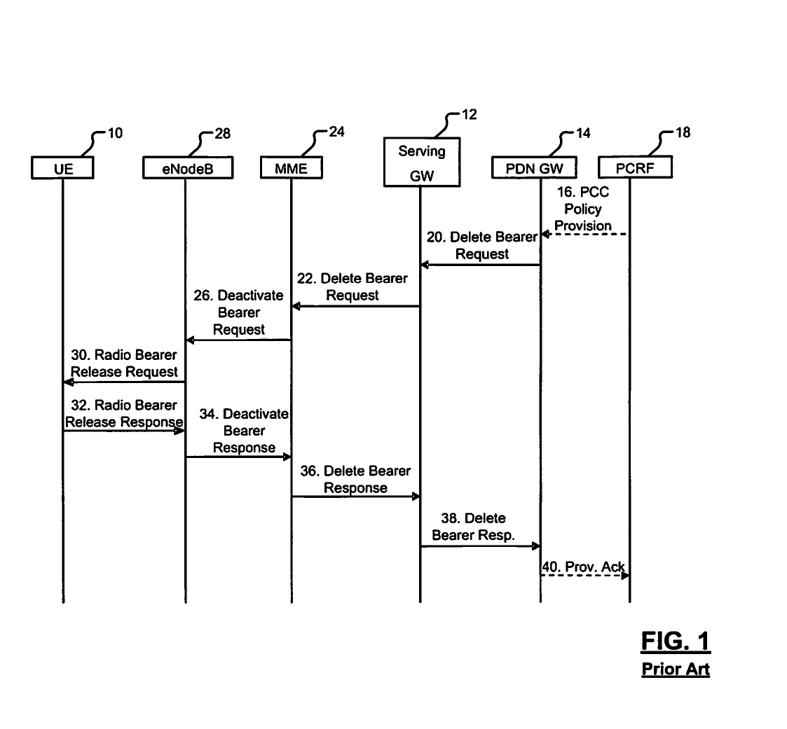

Referring now to FIG. 1, a message flow diagram illustrating a conventional method of managing deactivation of a dedicated bearer in an evolved packet system is shown. TS 23.401 describes a packet data network (PDN) gateway (GW) initiated bearer deactivation procedure corresponding to UE 10. This procedure is described briefly below. The deactivation procedure is directed to S5/S8 links between a serving GW 12 and a PDN GW 14, which are associated with a general packet radio service (GPRS) tunneling protocol and/or an Internet Engineering Task Force (IETF) protocol. The UE 10 is active.

In step 16, a policy and changing rules function (PCRF) entity 18 may send a policy and charging control (PCC) decision provision (QoS policy) message to the PDN GW 14. When a PCC architecture is not present, the PDN GW 14 may apply a local QoS policy. In step 20, the PDN GW 14 is triggered by the QoS policy to initiate a dedicated bearer deactivation procedure. The PDN GW 14 sends a delete dedicated bearer request message to the serving GW 12.

In step 22, the serving GW 12 sends the delete dedicated bearer request message to a mobility management entity (MME) 24. In step 26, the MME 24 forwards the deactivate bearer request message to an evolved node base station (eNodeB) 28. In step 30, the eNodeB 28 sends a radio bearer release request message to the UE 10.

In step 32, the UE 10 removes uplink (UL) traffic flow templates (TFTs) corresponding to the released radio bearer to complete deactivation of the dedicated bearer. The term release refers to the no longer use of a bearer or network device. The UE 10 then acknowledges the release of the radio bearer by sending a radio bearer release response message to the eNodeB 28. In deactivating the dedicated bearer and releasing the radio bearer, IP connectivity for the UE 10 is dropped.

In step 34, the eNodeB 28 acknowledges the bearer deactivation and sends a deactivate bearer response message to the MME 24. In step 36, the MME 24 acknowledges the bearer deactivation by sending a delete dedicated bearer response message to the serving GW 12. In step 36, the serving GW 12 acknowledges the bearer deactivation by sending a delete dedicated bearer response message to the PDN GW 14.

In step 38, if the dedicated bearer deactivation procedure is triggered by a PCC decision provision message from the PCRF 18, the PDN GW 14 indicates to the PCRF 18 that the requested PCC decision was enforced by sending a provision acknowledgement message.

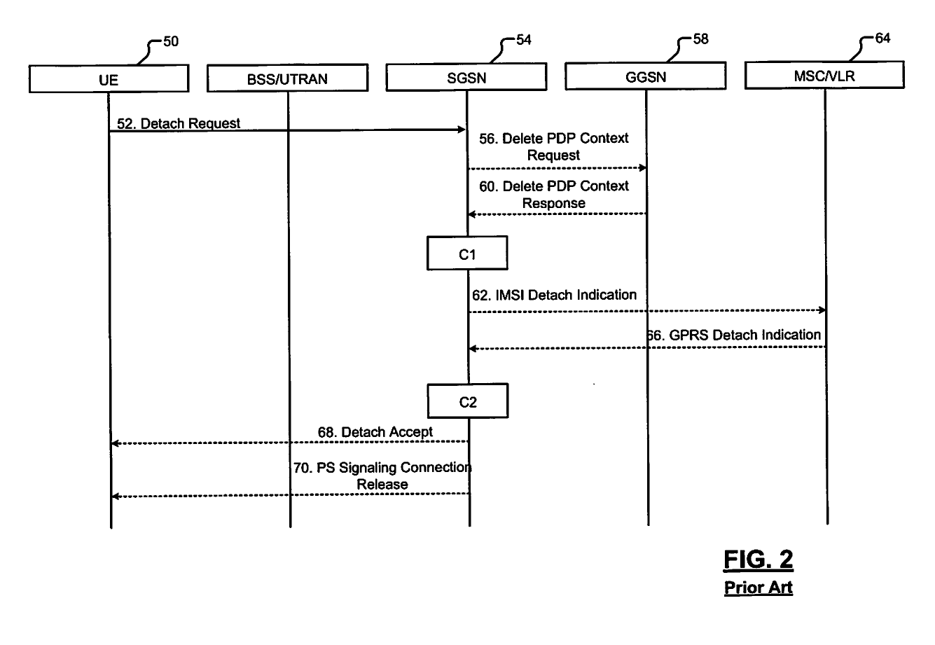

Referring now to FIG. 2, a message flow diagram illustrating a conventional method of managing detachment of UE 50 in a general packet radio service environment is shown.

In step 52, the UE 50 detaches by sending a detach request to a servicing general packet radio service support node (SGSN) 54. In step 56, when a GPRS is detached, active packet data protocol (PDP) contexts in GW GPRS support nodes (GGSNs), such as the GGSN 58, regarding the UE 50 are deactivated by the SGSN 54. This includes sending a delete PDP context request tunnel endpoint identification (TEID) to the GGSNs. In step 60, the GGSNs acknowledge the delete PDP context request with a delete PDP context response TEID.

In step 62, when international mobile subscriber identity (IMSI) is detached, the SGSN 54 sends an IMSI detach indication message to a mobile service switching center/visitor location register (MSC/VLR) 64.

In step 66, when the UE 50 remains IMSI-attached and is performing a GPRS detach, the SGSN 54 sends a GPRS detach indication message to the MSC/VLR 64. The MSC/VLR 64 removes the association with the SGSN 54 and handles paging and location update. When performing steps 52-66 IP connectivity for the UE 50 is dropped.

In step 68, when a switch off indicates that detach is not due to a switch off situation, the SGSN 54 sends a detach accept signal to the UE 50.

In step 70, when the UE 50 is GPRS detached, then the SGSN 54 releases a packet switched (PS) signaling connection with the UE 50. Customized applications for mobile network enhanced logic (Camel) procedures C1 and C2 are described in the TS 23.078 “3GPP™ Camel Stage 3-Phase 2”, which is incorporated herein by reference in its entirety. The above-described method of managing detachment of UE, as shown in FIG. 2, may be modified for detachment initiation by the SGSN and a HLR, as described in TS 23.060.

In the methods of FIGS. 1 and 2, when performing a deactivation and/or a detachment, IP connectivity for UE is released. By releasing the IP connectivity, the UE needs to reestablish IP connectivity when switching between a 3GPP™ network and a non-3GPP™ network in order to receive IP services. This establishment generally reduces network performance and has associated time delays.

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. Also, steps within a method may be executed in different order or concurrently without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

In the following description, a service request device (SRD) may refer to UE and/or a mobile node. A SRD may include equipment of an end user, such as a processor, a radio interface adaptor, etc. An SRD may include a mobile network device, a personal data assistant (PDA), a computer, etc.

Also, in the following description, the term IP connectivity may refer to connectivity provided for a SRD that allows for the reception of IP services by the SRD from, for example, a packet data network (PDN). The IP services may include real-time and non-real-time services, such as Web browsing, voice over Internet phone (VoIP), electronic mail (email), and real-time IP multimedia, as well as conversational and streaming services. For example only, a SRD may gain Internet protocol (IP) connectivity when in a visited public land mobile network (VLPMN) by communicating with and obtaining a local IP address from an access point (AP). Local IP address allocation may be performed with authentication and authorization of the SRD. After obtaining a local IP address, the SRD may select a wireless access point name (W-APN) identifier and generate a fully qualified domain name (FQDN). The W-APN identifier identifies one or more services requested by the SRD. The FQDN includes the W-APN network identifier and a VPLMN identifier. Other techniques for obtaining IP connectivity are described in 3GPP™ TSs, some of which are incorporated herein by reference.

Also, in the following description, the term mobility protocol may include a local mobility protocol and/or a global mobility protocol. A local mobility protocol may refer to a communication protocol used for mobility by a SRD between access points of a network, such as a public land mobile network (PLMN). The access points are in communication with different access routers. A global mobility protocol refers to a communication protocol used for mobility by a SRD between access points of different networks. The different networks may be different PLMNs.

A mobility protocol may include a mobile Internet protocol (MIP), which may refer to a host-based Internet protocol (IP) or a network-based IP, as further described in Internet Engineering Task Force (IETF) RFC 3344 and IETF RFC 3775 which are incorporated herein by reference in their entirety. A host-based IP may include a client mobile IP (CMIP), such as CMIPv4 and CMIPv6, or a dual stack mobile IP (DSMIP). A host-based IP is used when mobility management is handled by a SRD. A network-based IP may include a proxy MIP (PMIP), such as PMIPv4 and PMIPv6. A network-based IP may be used, for example, when mobility management is handled by a mobility management entity (MME) or other network device on behalf of a SRD.

In addition, in the following description various networks and network devices are disclosed. Although a particular number of each network device is shown, any number of each network device may be included. For example, in a home network and or a visited network any number of wireless access GWs (WAGs), home subscriber servers (HSSs), authentication authorization and accounting (AAA) servers, etc. may be included. Selection of one of each of the devices may be performed during communication with a SRD. Each of the network devices may be considered a remote network device relative to another network device.

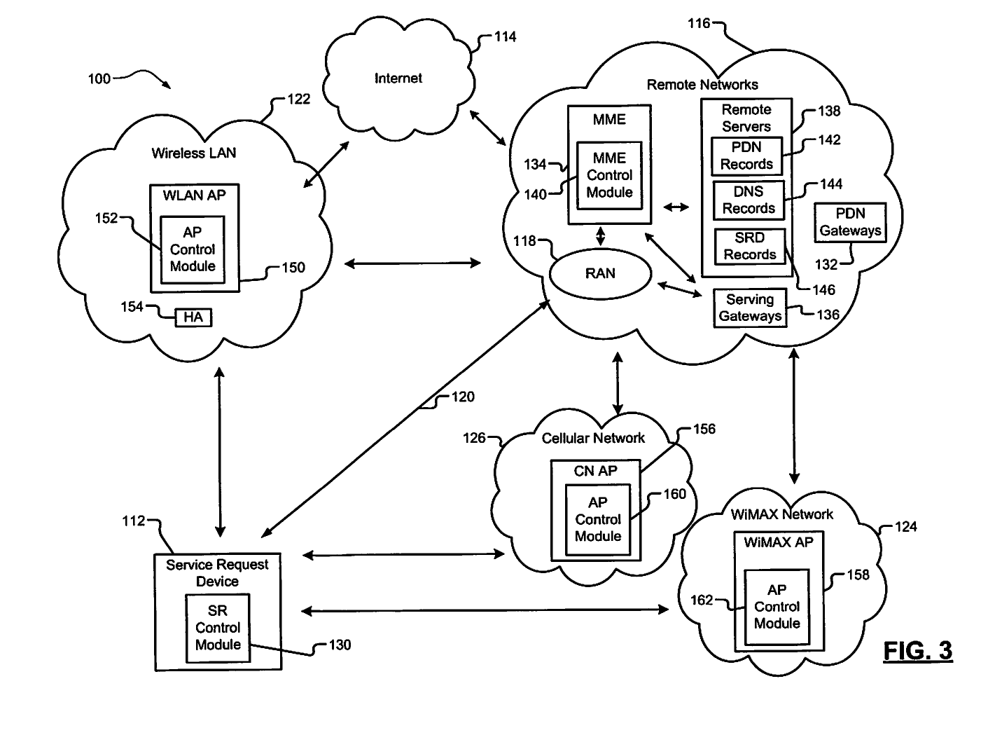

The following systems of FIGS. 3-7 may include 3GPP™ system networks and comply with 3GPP™ system technical specifications, some of which are stated herein.

Referring now to FIG. 3, a functional block diagram of an exemplary network system 100 is shown. The network system 100 includes a SRD 112 that may communicate with the Internet 114 and/or one or more remote networks 116. The SRD 112 may communicate with a radio access network (RAN) 118, such as an evolved universal terrestrial radio access network (EUTRAN) of the remote networks 116 as indicated by signal line 120 or may communicate with the remote networks 116 via an access network. Some examples of an access network are a wireless local area network (WLAN) 122, a Worldwide Interoperability for Microwave Access (WiMAX) network 124, and a cellular network 126.

The network system 100 allows for the detachment of the SRD 112 and/or deactivation of a bearer associated with the SRD 112 by one or more network devices without the SRD 112 experiencing a disconnection of IP connectivity. The detachment and/or deactivation may be triggered, initiated and/or controlled by a network device in the network system 100, such as by the SRD 112, by one of the access networks, by the RAN 118, a mobility management entity (MME) 134, by a serving GW or a PDN GW, such as one of the serving GWs 136 and PDN GWs 132, a WLAN AP 150, a cellular AP 156, a WIMAX AP 158, etc. This allows for the SRD 112 to switch between networks, such as between 3GPP™ and non-3GPP™ networks, while maintaining IP connectivity for one or more sessions. This allows for quick transitions and uninterrupted IP connectivity for the SRD 112.

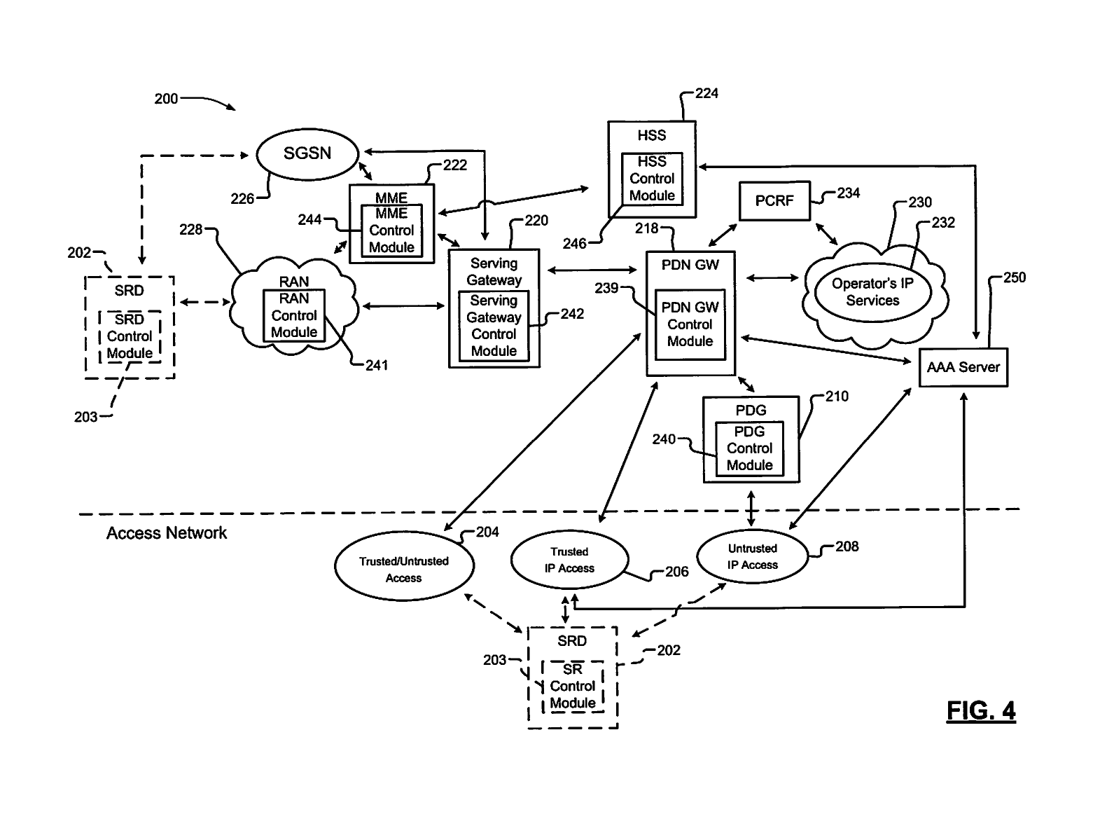

The network devices may include a control module. Control modules for the network devices 112, 118, 134, 150, 156, 158 are shown in FIG. 3. Other network device control modules are shown in FIGS. 4-7. The control modules may be referred to as or include a connection manager. A connection manager may track the active connections of the SRD 112 and/or other SRDs in the network system 100. The connection manager maintains session information identifying: the current sessions of the SRD 112, bearer information corresponding to the SRD 112, networks attached to the SRD 112, etc. Attachment may refer to a routing that is setup between the mobility MME 134 and a PDN GW for the routing of packets between the SRD 112 and a PDN.

Detachment may refer to detachment of the SRD 112 from a network and/or network device(s). Detachment may refer to the deletion or deactivation of bearer(s) corresponding with the SRD 112 and the network or network device(s). For example only, the bearer(s) may be associated with communication connections or tunnel(s) between the SRD 112 and a packet data network. A detachment may occur due to a request generated by the SRD 112, by some other network device, or based on a switch off of the SRD 112. Deactivation may refer to the release or no longer setup of a bearer, a default bearer and/or a dedicated bearer corresponding to a session of the SRD 112.

Example sessions are described herein. One example of a session includes the reception of cellular services by a SRD from a packet data network via a tunnel between a radio access network and the packet data network. The tunnel has one or more corresponding bearer(s), which may be deactivated. The deactivation may be initiated by the SRD or by some other network device. For example only, a detachment may be requested by a home subscriber server (HSS) when a subscriber's credit associated with an account is zero or below a predetermined amount.

In one embodiment the SRD 112 includes a connection manager and indicates when a session change is to occur. The SRD 112 may indicate when a session is to be switched between networks. For example only, the SRD 112 may switch from the cellular network 126 to the WLAN 122, which may include the switching of PDN GWs. The SRD 112 may provide an indication to a current PDN GW or other network device that a switch is to occur.

This indication may include one or more IP descriptors that indicate which bearers to deactivate, whether IP connectivity is to be maintained, whether basic connectivity is to be maintained, which PDNs and/or PDN GWs to remove or add in association with the SRD 112, etc. Basic connectivity does not include IP connectivity and allows for generic connectivity and base signaling, but does not allow for specific communication and quality of service (QofS) maintained IP services.

When basic connectivity is maintained, the MME 134 may retain information pertaining to the SRD 112. This allows the SRD 112 to return to a network and quickly setup bearer(s) and reestablish IP connectivity. The IP connectivity may be reestablished without use of a home network; a local network may establish the IP connectivity. Data may not be able to be transferred when basic connectivity is maintained and IP connectivity is deactivated, since a bearer is not activated.

The IP descriptors may provide policy and/or packet information, such as packet protocols indicating how packets are to be handled. The IP descriptors may provide access point names (APNs) for the PDNs and/or PDN GWs. An example descriptor is provided in FIG. 18.

An alternative to providing the above-described descriptor is for a PDN GW to create a correlation between a new connectivity obtained over a non-3GPP™ network and a current connectivity over a RAN (a 3GPP™ network). This correlation indicates that a release of a bearer associated with the RAN should not force the disconnection of IP connectivity over non-3GPP™. To provide this correlation is complex. Also since a SRD is aware that a handoff is to be performed between 3GPP™ and non-3GPP™ networks, detachment and/or deactivation of a bearer is more suitable via an indication by a SRD.

The network system 100 provides connectivity and/or mobility management. The connectivity management is provided in an efficient manner using one or more of the techniques described herein. Mobility management allows the SRD 112 to move between local and/or global networks. The mobility may be provided through establishment of Internet protocol (IP) connectivity between the SRD 112 and the remote networks 116.

The SRD 112 includes a service request control module 130 that provides connectivity protocol information to the remote networks 116. The service request control module 130 may identify a PDN GW, such as one of the PDN GWs 132, of the remote networks 116 to provide requested services. The SRD 12 accesses packet switched domain services via the selected PDN GW. The PDN GW may be located in a home PLMN (HPLMN). The SRD 112 may request various real-time and non-real-time services, such as Web browsing, voice over Internet phone (VoIP), electronic mail (email), and real-time IP multimedia, as well as conversational and streaming services.

The remote networks 116 may include 3GPP™ system networks, a VPLMN, a HPLMN, etc. The remote networks 116 may comply with [1], [2], TS 22.278 “3GPP™ Service requirements for the evolved packet system (EPS)”, TS 23.060 “General Packet Radio Service (GPRS) service description”, which are incorporated herein by reference in their entirety. The remote networks 116 may include the RAN 118, the PDN GWs 132, the MME 134, the serving GWs 136, and remote servers 138, such as home subscriber servers (HSSs). The MME 134 may include a MME control module 140 that supports connectivity and/or mobility of the SRD 112. The serving GWs 136 may include system architecture evolution (SAE) GWs.

The remote servers 138 may include PDN records 142, DNS records 144, and SRD records 146. The PDN records 142 include information regarding the services, connectivity protocols, and mobility protocols supported by the PDN GWs 132. The DNS records 144 include information regarding the services and connectivity protocols supported by packet data GWs (PDGs). The DNS records 144 may also include mobility protocols supported by the PDGs. The SRD records 146 include information regarding the subscriber and account associated with the SRD 12.

Each of the PDN GWs 132 may have a physical address (effective address) and/or one or more logical addresses, which are referred to as remote IP addresses. Each remote IP address may have an associated service and connectivity and mobility protocol and be assigned to the SRD 112. For example only, a remote IP address may be associated with home-based IP CMIPv6 and be used to provide VoIP service to the SRD 112.

When the SRD 112 initially accesses the network system 100, the MME 134, the PDN GWs 132, the serving GWs 136, and the remote servers 138 are unaware of the SRD preferred PDN, PDN GW, and IP services. The MME 134, the PDN GWs 123, the serving GWs 136 and the remote servers 138 may support multiple connectivity protocols and services. The SRD 112 may provide PDN, PDN GW and IP service information early on in an attachment process. This improves network performance and quickly provides the services desired by the SRD 112.

The WLAN 122 includes a WLAN access point (AP) 150 with an AP control module 152. The WLAN AP 150, for example, may be a base station, such as an evolved node B base station (eNodeB). The WLAN 150 may also include one or more home agents 154, such as routers. The AP mobility control module 152 facilitates authentication of the SRD 112 and the transfer of connectivity protocol information, mobility protocol information, PDN information, PDN GW information, and IP services information between the SRD 112 and network devices of the remote networks. The WLAN 22 may comply with one or more IEEE standards—e.g., 802.11, 802.11a, 802.11b, 802.11g, 802.11h, 802.11n, 802.16, and 802.20, and the like which are incorporated herein by reference in their entirety.

The cellular network 126 and the WiMAX network 124 may include a cellular network AP 156 and a WiMAX network AP 158 with respective AP control modules 160, 162, as shown. The AP control modules 156, 158 may also facilitate authentication of the SRD 112 and the transfer of connectivity and mobility protocol information, and PDN GW information between the SRD 112 and network devices of the remote networks 116.

During operation, the SRD 112 may move or roam between the networks 122, 124, 126 without losing connection to one or more of the remote networks 116. When in communication with the RAN 118, IP traffic flows between the RAN 118 and the serving GWs 136. When in communication with the networks 122, 124, 126, IP traffic flows between the networks 122, 124, 126 and the serving GWs 136.

When the SRD 112 accesses the remote networks 116 while roaming between the networks 122, 124, 126, connectivity and mobility tunnels, may be used to manage and maintain connectivity and mobility of the SRD 112. A mobility tunnel may include multiple bearers. When the SRD 112 switches between different networks, a host-based system or a network-based system may be used to establish a connectivity tunnel and/or a mobility tunnel. The connectivity tunnel may be a secured IP tunnel.

The host-based system may utilize CMIP or DSMIP protocols. CMIP versions 4 and 6 are described in IP mobility request for support memos RFC 3344 and in RFC 3775, which are incorporated herein by reference in their entirety. DSMIPv6 is described in “Mobile IPv6 support for dual stack, Hosts, and Routers (DSMIPv6)” of an Internet draft by the IPv6 working group of IETF, which is incorporated herein by reference in its entirety. The network-based system may utilize PMIP protocols. PMIP version 4 is described in an Internet-Draft titled “Mobility Management using Proxy Mobile IPv4” by Leung et al. and PMIPv6 is described in “Localized Mobility Management using Proxy Mobile IPv6” by Gundavelli, which are incorporated herein by reference in their entirety.

When a host-based protocol associated with version 4 networks, such as CMIPv4, is used, a serving GW may function as a foreign agent (FA) and provide routing services to the SRD 112. This may occur when the SRD 112 is registered with the PDN GW. The PDN GW performs as a home agent. The SRD 112 may receive IP configuration information contained in an agent advertisement message through CMIPv4 or link layer protocols.

When a host-based protocol associated with a version 6 network, such as CMIPv6, is used, a serving GW may function as an access router and provide routing services to the SRD 112. The PDN GW performs as a home agent. The SRD 112 may receive IP configuration information contained in a CMIPv6 router advertisement message through CMIPv6 or link layer protocols.

When a network-based protocol is used, a serving GW may function as a PMIP client (i.e., a PMIP agent (PMA)). The PDN GW performs as a PMIP home agent. A PMIP client allocates a SRD IP address and provides the SRD IP address to the SRD 112. The PMIP client performs PMIP mobility procedures.

Referring now to FIG. 4, a functional block diagram of an exemplary network system 200 illustrating trusted and untrusted non-roaming access is shown. Access from a 3GPP™ network and from a non-3GPP™ is shown. The network system applies to host-based and network-based mobility and includes a SRD 202 with an SRD control module 203 that obtains network access to receive services, such as operator IP services 234, from a PDN 236. The SRD 202 establishes Internet protocol (IP) connectivity with a PDN GW 218 to receive the services 234. The services 234 may include real-time and non-real-time services, such as Web browsing, voice over Internet phone (VoIP), electronic mail (email), and IP multimedia subsystem (IMS) services, packet switched service sequence (PSS) services, conversational and streaming services, etc.

The network system 200 includes an access network (AN), such as a non-3GPP™ network, and a HPLMN. The SRD 202 may access the HPLMN directly or from an access network. When accessing the HPLMN directly, the SRD 202 may obtain access via a SGSN 226 or a RAN 228. When accessing the HPLMN from the access network, the SRD 202 may use trusted/untrusted access 204, such as trusted/untrusted non-3GPP™ IP access or 3GPP™ access, or use trusted IP access 206, such as trusted non-3GPP™ IP access. A SRD 202 may also access the HPLMN from the access network using untrusted IP access 208, such as untrusted non-3GPP™ IP access. The untrusted IP access 208 is provided through a PDG 210. The SRD 202 may access the HPLMN using procedures associated with either the host-based access or the network-based access. The SRD 402 may be a trusted or untrusted network device.

The network system 200 may include the PDN GW 218, a serving GW 220, a MME 222, a HSS 224, the SGSN 226 and the RAN 228. The RAN 228 may be for example an evolved universal terrestrial radio access network (EUTRAN).

The SGSN 226 may be in communication with a GSM enhanced data rates for GSM evolution (EDGE) RAN (GERAN) and/or a universal terrestrial RAN (UTRAN). The PDN GW 218, the RAN 228, the serving GW 220, the MME 222, and the HSS 224 respectively include a PDN GW control module 239, a RAN control module 241, a serving GW control module 242, a MME control module 244, and a HSS control module 246.

The PDN GW 218 is in communication with a PCRF entity 234 and the PDN 230. The PCRF entity 234 may be used to terminate reference points between network devices, such as reference points associated with the serving GW 220 and the PCRF entity 234. Reference points refer to communication links between network devices.

The serving GW 220 may be a SAE GW or a wireless access GW (WAG). The MME 222 is in communication with each of the RAN 228, the serving GW 220, the SGSN 226, and the HSS 224. The MME 222 performs SRD tracking and security functions. The serving GW 220 is in communication with the PDN GW 218, the RAN 228, and the SGSN 226. The SGSN 226 may perform MME selection and/or serving GW selection.

The HSS 224 may have authentication and subscriber profile information, such as for a subscriber of the SRD 202, to access the PDN 230. The HSS 224, the MME 222, and/or the serving GW 220 may perform PDN, PDN GW, and IP services selections. The selections may be based on PDN, PDN GW, and IP service information provided by the SRD 202. For example only, the HSS 224 may authenticate the subscriber after an invoked tunnel establishment request by the SRD 202.

The HPLMN may also include an AAA server 250 that provides authentication, authorization and accounting information and subscriber profile information to the PDN GW 218 and/or the HSS 224. The stated information may be provided to the access network, for example, when trusted network-based IP access is performed. This information may be obtained from the HSS 224. For example, the AAA server 250 may authenticate the subscriber with the HSS 224 after an invoked tunnel establishment request by the SRD 202.

The HSS 224 may have authentication and subscription data and quality of service profiles for the subscriber. The HSS 224 may also store an IP address of the AAA server 250 to which the SRD 202 is registered. The HSS 224 may perform PDN GW selection.

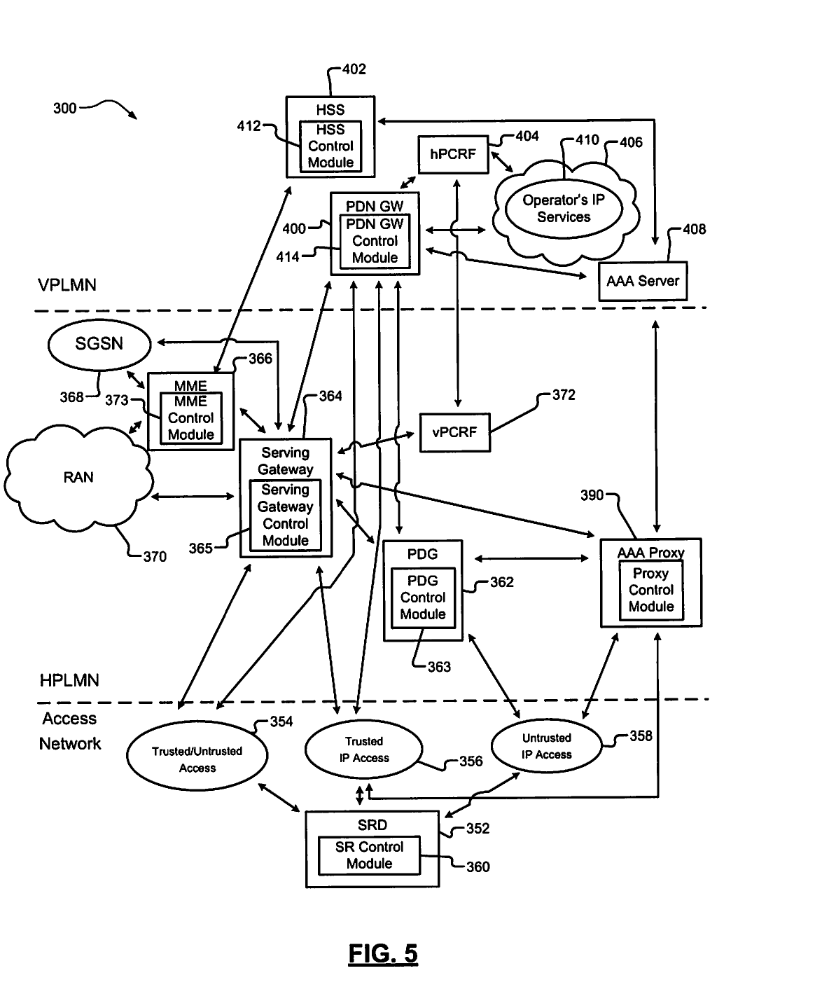

Referring now to FIG. 5, a functional block diagram of an exemplary network system 300 illustrating trusted and untrusted roaming access is shown. The network system 300 applies to host-based and network-based mobility. The network system 300 includes an access network, a VPLMN, and a HPLMN. A SRD 352 may access the HPLMN through the access network via the VPLMN.

The SRD 352 may access the VPLMN from the access network using trusted/untrusted access 354, such as trusted/untrusted non-3GPP™ IP access or 3GPP™ access, or using trusted IP access 356, such as trusted non-3GPP™ IP access. A SRD 352 may also access the VPLMN from the access network using untrusted IP access 358, such as untrusted non-3GPP™ IP access. The untrusted IP access 358 is provided through a PDG 362.

The network system 300 includes the SRD 352 with a SR control module 360. The SRD 352 may access the VPLMN using procedures associated with either the host-based access or the network-based access. The SRD 352 may be a trusted or untrusted network device. Untrusted IP access to the HPLMN is provided via a PDG 362 of the VPLMN.

The VPLMN includes the PDG 362 and a serving GW 364. The PDG 362 and the serving GW 364 respectively include a PDG control module 363 and a serving GW control module 365. The SRD 352 may communicate with the PDG 362 directly or via the serving GW 364. The serving GW 364 is in communication with a MME 366, a SGSN 368, a RAN 370, and a visiting PCRF (vPCRF) device 372. The MME includes a MME control module 373.

The MME 366 performs SRD tracking and security functions. The MME 366 may perform PDN GW and/or serving GW selection. The SGSN 368 may perform MME selection, PDN GW selection, and/or serving GW selection. The vPCRF device 372 may be used to terminate reference points between network devices, such as references points associated with PDN GWs, PCRF devices, devices of a packet data network, etc.

The VPLMN may also includes a AAA proxy server 380 that provides authentication, authorization and accounting information and subscriber profile information to the serving GW 364, the PDG 362 and/or the AN. The stated information may be provided to the AN, for example, when trusted network-based IP access is performed.

The HPLMN includes a PDN GW 400 that is in communication with a HSS 402, a home policy and changing rules function (hPCRF) device 404, a PDN 406 and an AAA server 408. The PDN 406 provides operator IP services 410. The HSS 402 and the PDN GW 400 respectively include a HSS control module 412 and a PDN GW control module 414.

The HSS 402 may have authentication and subscription data required for a subscriber, such as a subscriber associated with the SRD 352, to access an interworking service. The HSS 402 may have quality of service profiles, authentication, and subscription data for the subscriber. The HSS 402 may also store an IP address of the AAA server 408 to which the SRD 352 is registered. The HSS 402 may perform PDN GW selection. The hPCRF device 404 may be used to terminate reference points between network devices, such as reference points associated with the serving GW 364, the vPCRF 372, and the hPCRF 404.

The AAA server 408 provides authentication, authorization and accounting information and subscriber profile information. This information may be obtained from the HSS 402. For example, the AAA server 408 may authenticate the subscriber with the HSS 402 after an invoked tunnel establishment request by the SRD 352.

The network system 300, as well as other systems described herein may comply with 3GPP™ TS 23.401 (General Packet Radio Service Enhancements for Evolved Universal Terrestrial Radio Access Network E-UTRAN Access), 3GPP™ TS 23.402 (Architecture Enhancements for Non-3GPP™ Accesses), and 3GPP™ TS 23.203 (Policy and Charging Control Architecture), which are incorporated herein by reference in their entirety.

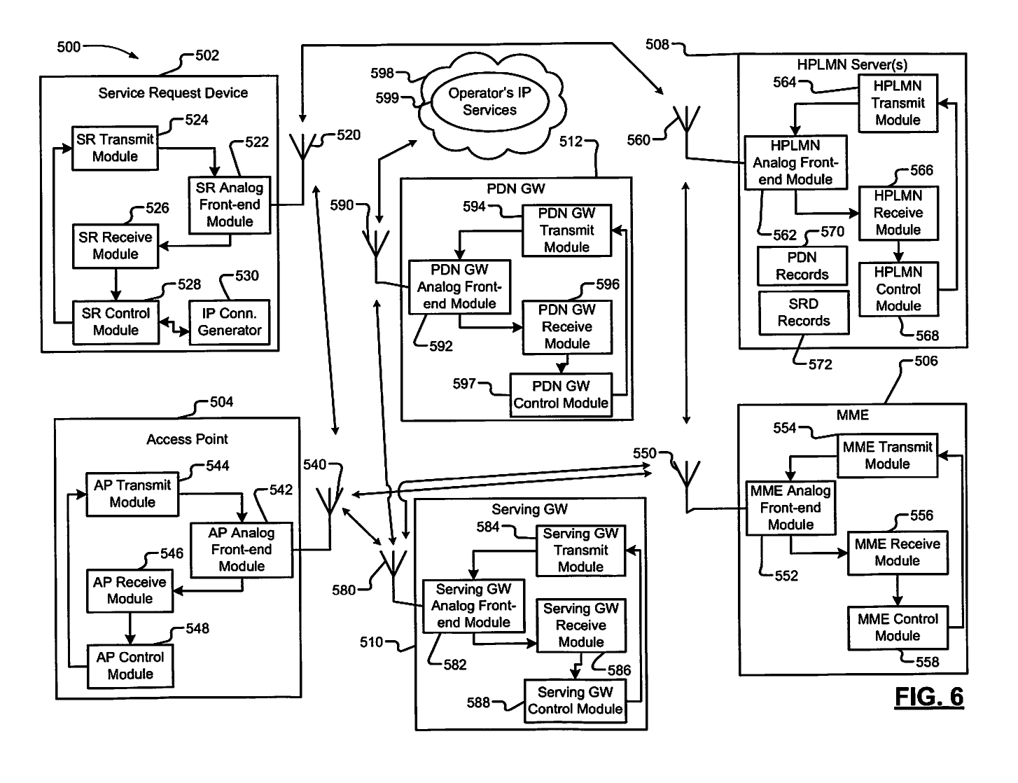

Referring now to FIG. 6, a functional block diagram of an exemplary network system 500 is shown. The network system 500 includes a SRD 502, an AP 504, a MME 506, and HPLMN server(s) 508. The AP 504 may include a RAN, a WLAN, a WiMAX network, a cellular network, etc. The HPLMN server(s) may include a HSS, an AAA server, a remote server, etc. The SRD 502 may provide the AP 504 with service request information, IP connectivity protocol information, PDN information, and/or PDN GW information. The SRD 502 may communicate with the HPLMN server(s) 508 via the AP 504 and/or a serving GW 510 to setup connectivity and mobility tunnel(s), for communication between the SRD 502 and the a PDN GW 512. The tunnel(s) may include a connectivity tunnel and/or a mobility tunnel.

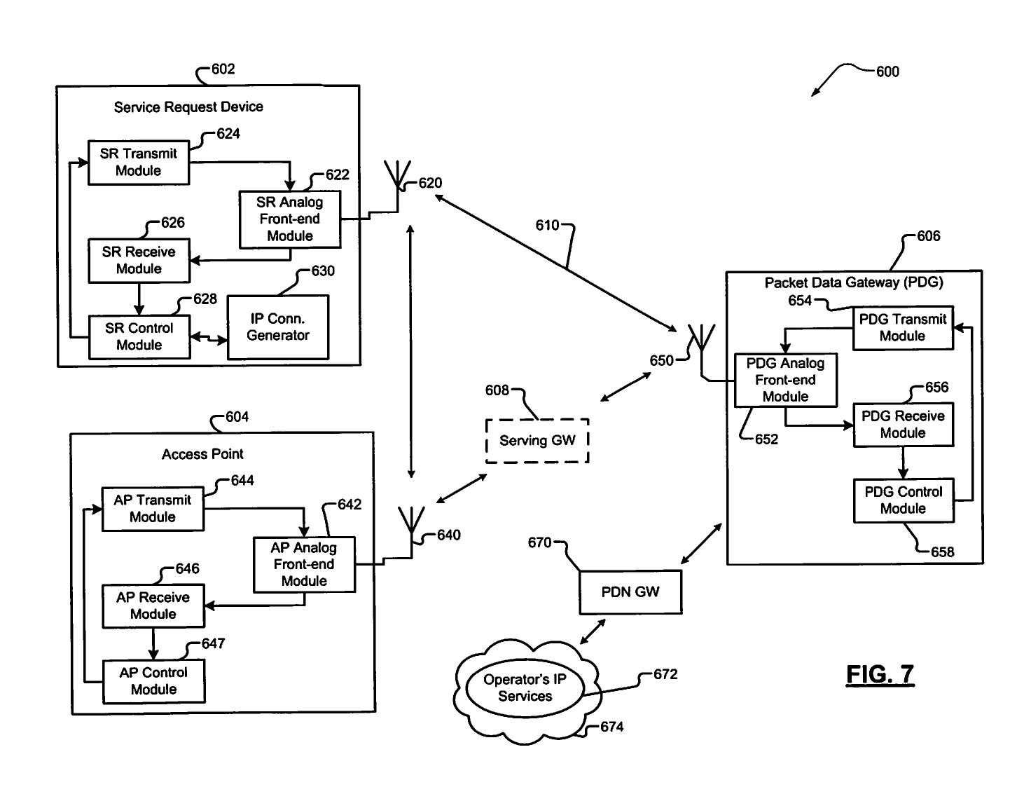

The SRD 502 may include an antenna 520, an SR analog front-end module 522, a SR transmit module 524, a SR receive module 526, and a SR control module 528. The SR analog front-end module 522 may transmit signals generated by the SR transmit module 524 via the antenna 520 and may output signals received from the antenna 520 to the SR receive module 526. The SRD 502 may also include an IP connectivity generator 530 for the generation of IP descriptors and/or IP connectivity indicators, as described herein. An IP connectivity generator may be included in one of the other network devices, such as in the AP 504, MME 506, the serving GW 510, the PDN GW 512, a PDG, such as the PDG 606 that shown in FIG. 7, etc. The IP connectivity generators of the network devices 504, 506, 510, 512, 606 may be respectively in communication with the control modules 548, 568, 558, 588, 597, 658.

The AP 504 may include an antenna 540, an AP analog front-end module 542, an AP transmit module 544, an AP receive module 546, and an AP control module 548. The AP analog front-end module 542 may transmit signals generated by the AP transmit module 544 via the antenna 540 and may output signals received from the antenna 540 to the AP receive module 546.

The MME 506 may include an antenna 550, a MME analog front-end module 552, a MME transmit module 554, a MME receive module 556, and a MME control module 258. The MME analog front-end module 554 may transmit signals generated by the MME transmit module 554 via the antenna 550 and may output signals received from the antenna 550 to the MME receive module 556.

The HPLMN server(s) 508 may include an antenna 5260, a HPLMN server(s) analog front-end module 562, a HPLMN server(s) transmit module 564, a HPLMN server(s) receive module 566, and a HPLMN server(s) control module 568. The HPLMN server(s) analog front-end module 562 may transmit signals generated by the HPLMN server(s) transmit module 564 via the antenna 560 and may output signals received from the antenna 560 to the HPLMN server(s) receive module 566. The HPLMN server(s) 508 may include PDN records 570 and SRD records 572.

The serving GW 510 an antenna 580, a serving GW analog front-end module 582, a serving GW transmit module 584, a serving GW receive module 586, and a HPLMN server(s) control module 588. The serving GW analog front-end module 582 may transmit signals generated by the serving GW transmit module 584 via the antenna 280 and may output signals received from the antenna 580 to the serving GW receive module 586.

The PDN GW 512 an antenna 590, a PDN GW analog front-end module 592, a PDN GW transmit module 594, a PDN GW receive module 596, and a PDN GW control module 597. The PDN GW analog front-end module 592 may transmit signals generated by the PDN GW transmit module 594 via the antenna 590 and may output signals received from the antenna 590 to the PDN GW receive module 596. The PDN GW 512 may be in communication with a PDN 298 that provides operator IP services 599.

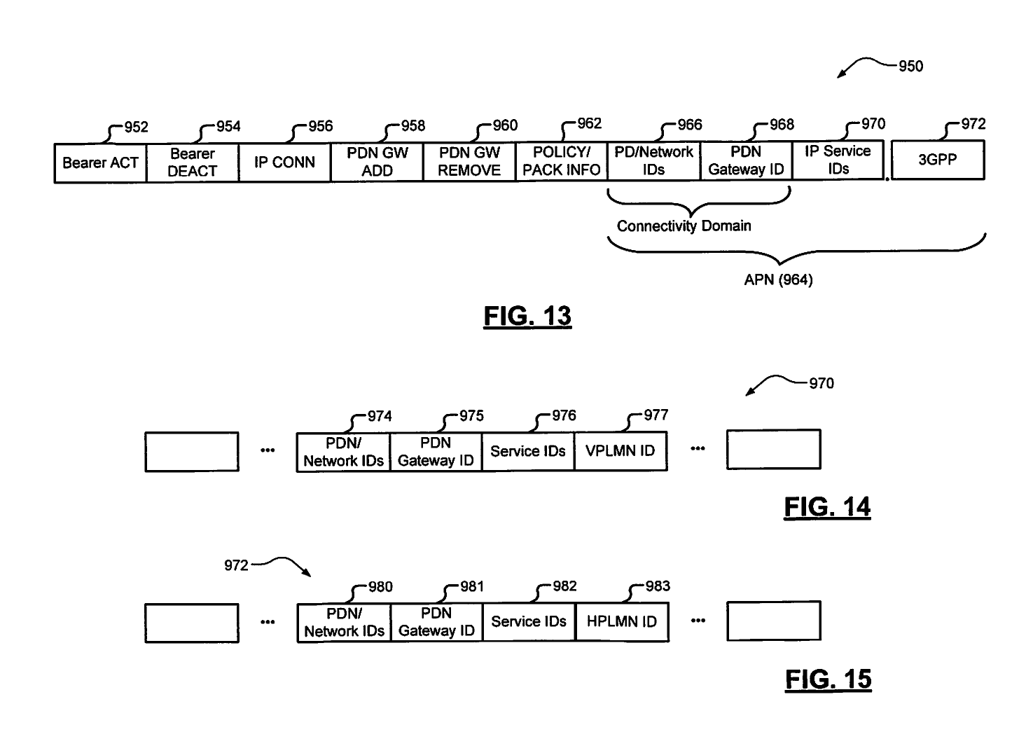

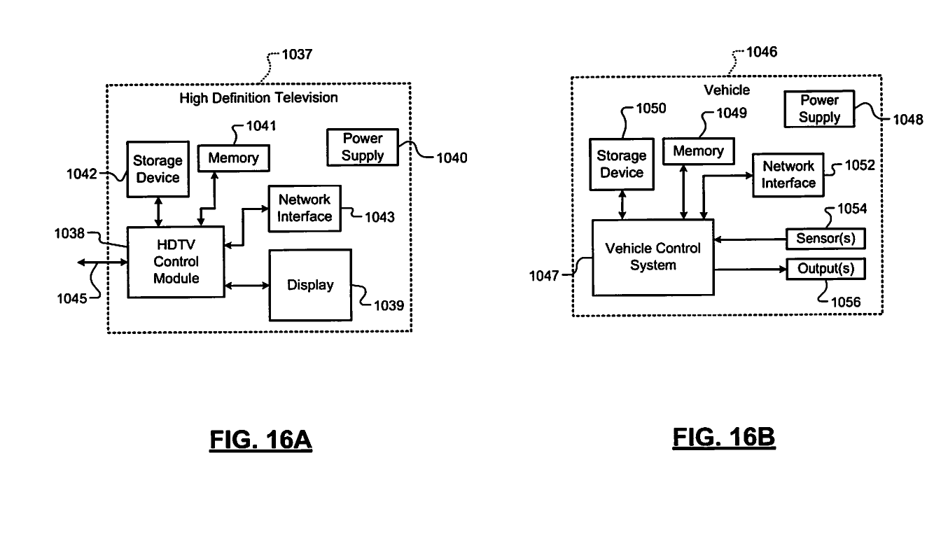

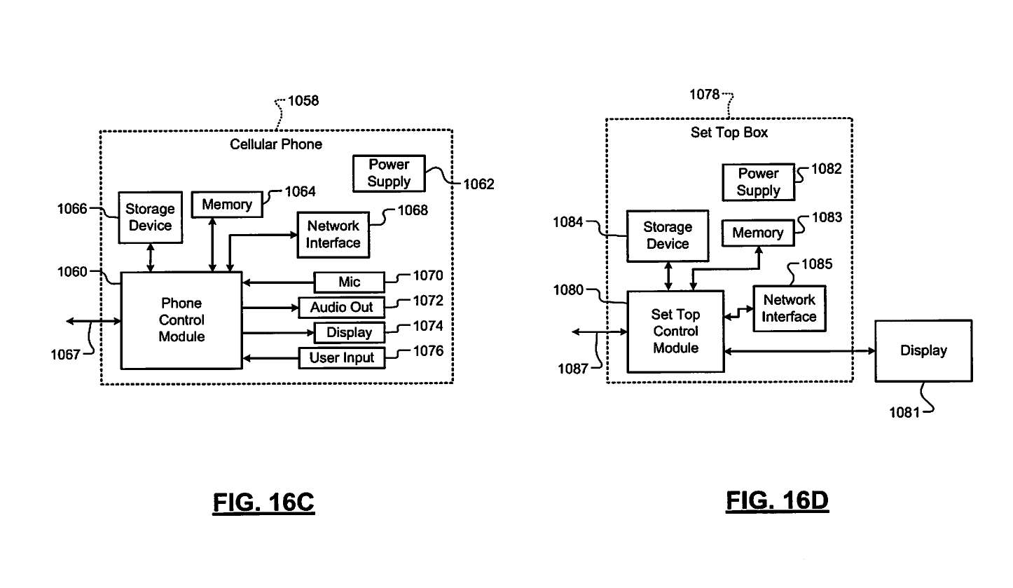

The SRD 502 initiates an information exchange between the SRD 502 and the AP 504. The SR control module 528 may generate an access point name (APN), with a PDN descriptor, or other PDN or IP service indication, such as a fully qualified domain name (FQDN). The PDN descriptor may identify a packet data network (PDN), a PDN GW, and IP service(s). An example of an access point name is shown in FIG. 13 and example FQDNs are shown in FIGS. 14 and 15.

An access point name may be generated by the PDN description generator 530. In one embodiment, the SRD 502 performs an attachment request and receives an indication of a selected connectivity protocol, mobility protocol, and IP service(s) and a selected PDN GW through which requested services may be provided.

An SRD, when attaching to a network system, may use a default IP access service to enable IP connectivity. The SRD does not need to perform any explicit activation procedure to transfer data. For example and with respect to a GPRS, a packet data protocol context activation procedure is performed along with a GPRS attachment procedure.

When a SRD attaches to a network system, the SRD may instead of or in addition to using a default IP access service may provide and receive mobility protocol and PDN GW information. This information may be provided early on in an attachment process. When a SRD is incapable of providing connectivity domain and IP service information, a connectivity domain and IP services may be selected by a network and used as a default.

One or more embodiments disclosed herein enable a mobility mode. The mobility mode refers to the ability of a SRD to roam between local and/or global networks. The mobility mode is setup based on SRD and network system mobility capabilities, mobility preferences, and SRD profiles and may refer to selected mobility protocols for IP connectivity and handoff, as well as a selected PDN GW. The decision to operate in a mobility mode may be made by a home network, such as a HPLMN, and may change based on updated SRD parameters and/or network system parameters.

Referring now to FIG. 7, a functional block diagram of an exemplary network system 600 is shown. The network system 600 includes a SRD 602, an AP 604 and a PDG 606. The SRD 602 communicates with the AP 604 to select the PDG 606. The SRD 602 may communicate with the PDG 606 via the AP 604 and a wireless access GW (WAG) 608 to setup connectivity and mobility tunnel(s), designated by line 610, for communication between the SRD 602 and the PDG 606. The tunnel(s) 610 may include a connectivity tunnel and/or a mobility tunnel.

The SRD 602 may include an antenna 620, an SR analog front-end module 622, a SR transmit module 624, a SR receive module 626, and a SR control module 628. The SR analog front-end module 622 may transmit signals generated by the SR transmit module 624 via the antenna 620 and may output signals received from the antenna 620 to the SR receive module 626. The SRD 602 may include a PDN description generator 630 for the generation of a PDN descriptor.

The AP 604 may include an antenna 640, an AP analog front-end module 642, an AP transmit module 644, an AP receive module 646, and an AP control module 647. The AP analog front-end module 642 may transmit signals generated by the AP transmit module 644 via the antenna 640 and may output signals received from the antenna 640 to the AP receive module 646. The AP 604 may also include an AP local DNS server 648 with DNS records 649. The SR control module 628 may access or request information in the DNS records 649 when performing a DNS query.

The PDG 606 may include an antenna 650, a PDG analog front-end module 652, a PDG transmit module 654, a PDG receive module 656, and a PDG control module 658. The PDG analog front-end module 606 may transmit signals generated by the PDG transmit module 654 via the antenna 650 and may output signals received from the antenna 650 to the PDG receive module 656. The PDG 606 may also include a remote DNS server 660 with DNS records 662. The SR control module 628 may access or request information in the DNS records 662 when performing a DNS query.

The SRD 602 initiates an information exchange between the SRD 602 and the AP 604. The SR control module 628 may generate a descriptor that includes an APN, a FQDN, an IP connectivity indicator, or other PDN and IP service indication. The APN may identify a PDN that the SRD 602 selects as the local network of the AP 604. The SRD 602 may also generate a FQDN to request services and to identify a local and/or remote network that may include the local network of the AP 604. The FQDN may include a PDN descriptor identifying the PDN and PDN GW preferred by the SRD 602.

When the connectivity protocol is host-based, the SR control module 628 may set up the connectivity tunnel between the SRD 602 and the PDG 606 and/or a serving GW of a remote network using a host-based protocol (e.g. CMIP). The PDG 606 may respectively function as a FA or as an access router when the CMIP is MIPv4 or MIPv6.

When the connectivity protocol is network-based, the PDG control module 658 may set up the connectivity tunnel between the SRD 602 and the PDG 606 and/or between the PDG 606 and a serving GW using a network-based protocol (e.g. PMIP). The PDG 606 may function as a PMA. The SRD 602 may connect to the PDG 606 via the connectivity tunnel set up between the SRD 602 and the PDG 606.

The SRD 602 may communicate with a remote network via the mobility tunnel when the SRD 602 roams from, for example, one local network to another (e.g., from a WLAN to a cellular network). The serving GW 608 switches the mobility tunnel from one local network to another when the SRD 602 roams between local networks.

An identification of a PDN, a PDN GW and IP services that are preferred by a SRD may be provided during a DNS query. The stated identification may occur during W-APN resolution. W-APN resolution includes identification of services requested by a SRD and determination of which PDGs support those services. W-APN resolution occurs before tunnel establishment. Tunnel establishment refers to the establishment of connectivity and mobility tunnels between a SRD and/or a serving GW and a selected PDG.

When performing a DNS query, the AP 604 and/or the PDG 606 may access a remote network 670 to obtain PDG information. The remote network 670 may include a remote DNS server 672 with DNS records 674.

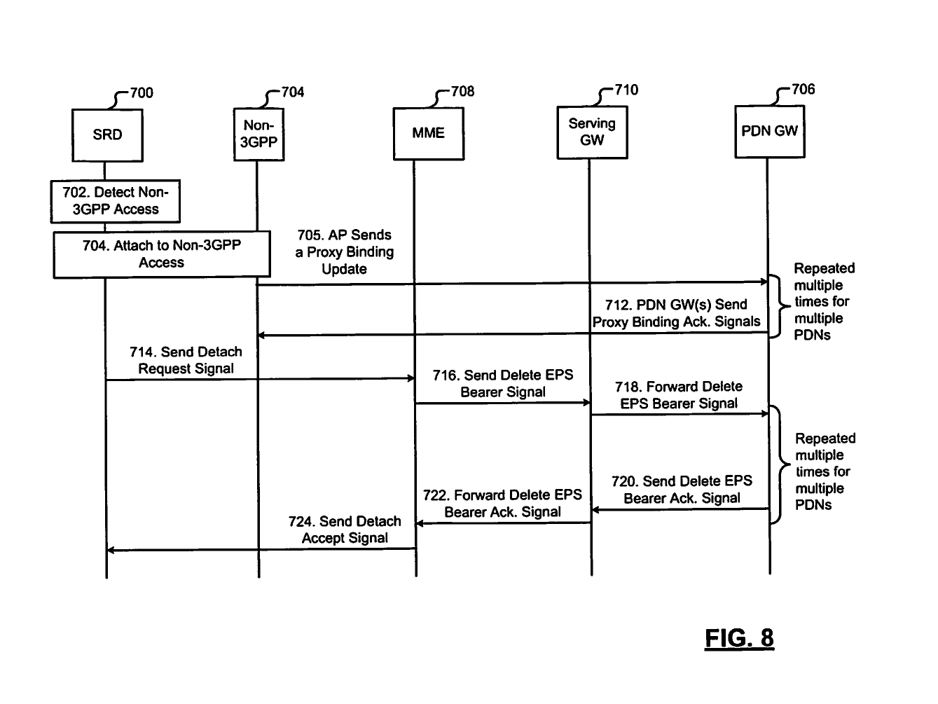

The network systems of FIGS. 3-7 may be used in implementing the methods of the following FIGS. 8-12. The methods of FIGS. 8-12 may begin with the SRDs attached to a 3GPP™ network. Although the methods are primarily described with respect to a switch between a 3GPP™ and a non-3GPP™ network are described, the methods may apply to a switch between 3GPP™ networks or a switch between non-3GPP™ networks. Also, the methods may apply to a switch from a non-3GPP™ network to a 3GPP™ network.

The embodiments of the present disclosure provide various detachment and deactivation methods. The detachment methods include detachment of an SRD from a network and/or one or more network devices. The deactivation methods include deactivation of one or more sessions of a SRD. The detachment and deactivation may be facilitated by the SRD and one or more of the network devices. A deactivation may be released from one or more of the network devices. The network device(s) may include, for example, a RAN, an AP, a SGSN, a MME, a PDN GW, a serving GW, a HSS, etc. The detachment and/or deactivation may include deactivation of 3GPP™ access or non-3GPP™ access.

Referring now to FIG. 8, a message flow diagram illustrating a method of managing detachment when initiated by a SRD 700 from 3GPP™ (first network) access and attachment to non-3GPP™ (second network) access is shown.

In step 702, the SRD 700 detects non-3GPP™ access. The SRD 700 detects a non-3GPP™ network and may decide to attach to and setup one or more sessions in the non-3GPP™ network. In step 704, the SRD 702 attaches to a non-3GPP™ network 704 associated with the non-3GPP™ access. In step 705, the non-3GPP™ network 704 sets up a tunnel between the SRD and a PDN GW 706 by sending a proxy binding update signal to the PDN GW 706. The non-3GPP™ network 704 updates the location of the SRDs using a network-based mobility protocol, such as PMIP. The proxy binding update signal may be passed to the PDN GW 706 via a MME 708 and a serving GW 710.

In step 712, the PDN GW 706 confirms the tunnel setup by sending a proxy binding acknowledgement signal. The steps 705 and 712 may be repeated multiple times for setup of connectivity for the SRD 700 to multiple PDNs. Steps 705 and 712 may include host-based mobile IP signalling, when a host-based mobility protocol is used. The host-based signalling may be between the SRD 700 and the PDN GW 706. At the end of step 712, attachment of the SRD 700 to the non-3GPP™ network 704 is complete.

In step 714, the SRD 700 initiates a detach procedure by sending a detach request signal. The detach procedure may be initiated by the SRD 700 from a RAN, such as from an EUTRAN or an UTRAN, in the 3GPP™ network. The detach request signal may include a descriptor, such as an IP descriptor that indicates whether IP connectivity with the PDN GW 706 should be maintained or released. The detach request may also include a detach type, packet-temporary mobile subscriber identity (P-TMSI), a P-TMSI signature, a switch off indicator, etc.

The detach type may indicate which type of detach is to be performed, such as GPRS detach only, IMSI detach only or combined GPRS and IMSI detach. The switch off indicator indicates whether detach is due to a switch off situation or not. The P-TMSI signature may be used to check the validity of the detach request message. When the P-TMSI signature is not valid or is not included, an authentication procedure may be performed.

In step 716, the MME 708 sends a delete evolved packet system (EPS) bearer request signal to the serving GW 710 based on the detach request signal from the SRD 700. The delete EPS bearer request signal may indicate to the serving GW 710 not to release the IP connectivity for the SRD 700, at least with respect to the non-3GPP™ network 704. In step 718, the serving GW 710 may forward the delete EPS bearer request signal to the PDN GW 706. As a result, IP connectivity for the SRD 700 with the PDN GW 706 may be maintained.

In step 720, the PDN GW 706 responds to the delete EPS bearer request signal by sending an delete EPS bearer acknowledgement signal to the serving GW 710. Steps 718-720 may be repeated as many times as the number of PDNs connected to (in communication with) the SRD through different PDN GWs. In step 722, the serving GW 710 forwards the delete EPS bearer acknowledgement signal to the MME 708. In step 724, the MME 708 may send a detach accept signal to the SRD 700 based on the delete EPS bearer acknowledgement signal.

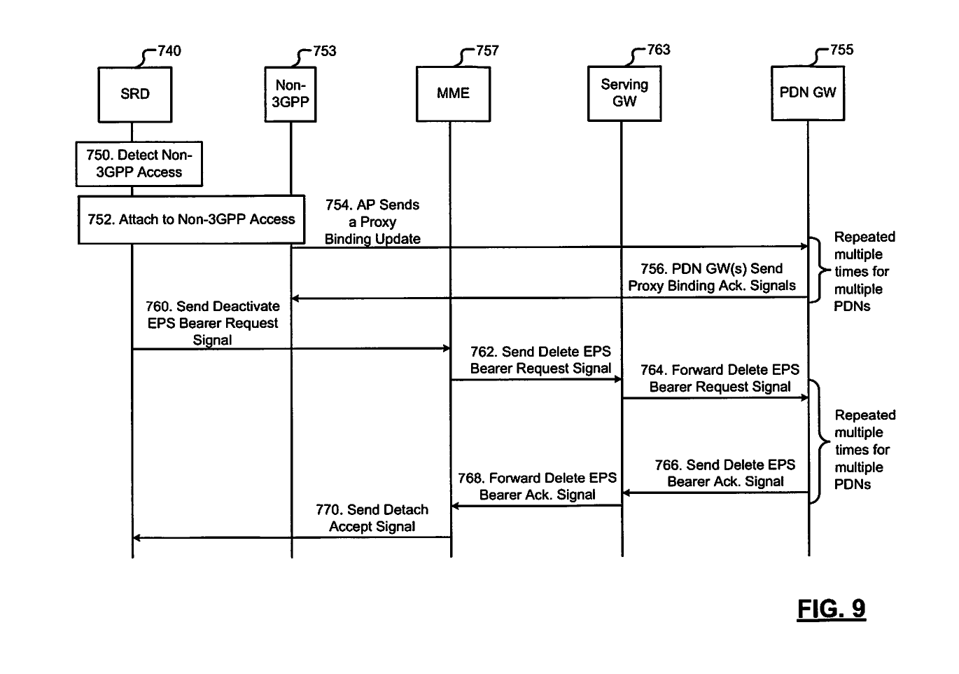

Referring now to FIG. 9, a message flow diagram illustrating a method of managing bearer deactivation when initiated and determined by a SRD 740 is shown.

In step 750, the SRD 740 detects non-3GPP™ access. In step 752, the SRD 740 attaches to a non-3GPP™ network 753 associated with the non-3GPP™ access. In step 754, the non-3GPP™ network sets up a tunnel between the SRD 740 and a PDN GW 755 by sending a proxy binding update signal to the PDN GW 755. The non-3GPP™ network 753 updates the location of the SRD 740 using a network-based mobility protocol, such as PMIP.

In step 756, the PDN GW 755 confirms the tunnel setup by sending a proxy binding acknowledgement signal. Steps 754 and 756 may be repeated multiple times for setup of connectivity for the SRD 740 to multiple PDNs. Steps 754 and 756 may include host-based mobile IP signalling, when a host-based mobility protocol is used. The host-based signalling is between the SRD 740 and the PDN GW 755.

In step 760, the SRD 740 initiates a deactivation procedure for an EPS bearer by sending a deactivate EPS bearer request signal to a MME 757. The SRD 740 may send the deactivate EPS bearer request signal over a radio access network for one or more PDNs.

The deactivate EPS bearer request signal may include a descriptor, such as an IP connectivity indicator that indicates whether IP connectivity with the PDN GW 755 should be released. The descriptor may also include one or more APNs, and associate an IP connectivity indicator to each APN to indicate which APNs are to be used and which APNs are not to be used.

In step 762, the MME 757 sends a delete EPS bearer request signal to a serving GW 763 based on the deactivate EPS request signal from the SRD. The delete EPS bearer request signal may indicate to the serving GW 763 not to release the IP connectivity for the SRD 740. The delete EPS bearer request signal may also include APN information as provided in step 760. In step 764, the serving GW 763 may forward the delete EPS bearer request signal to the PDN GW 755. As a result, IP connectivity for the SRD 740 with the PDN GW 755 may be maintained,

In step 766, the PDN GW 755 responds to the delete EPS bearer request signal by sending an delete EPS bearer acknowledgement signal to the serving GW 763. In step 768, the serving GW 763 forwards the delete EPS bearer acknowledgement signal to the MME 757. Steps 764-766 may be repeated as many times as the number of APNs, PDN GWs, or PDNs connected to (in communication with) the SRD 740 that the SRD requested to deactivate. In step 770, the MME 757 may send a deactivate accept signal to the SRD based on the delete EPS bearer acknowledgement signal.

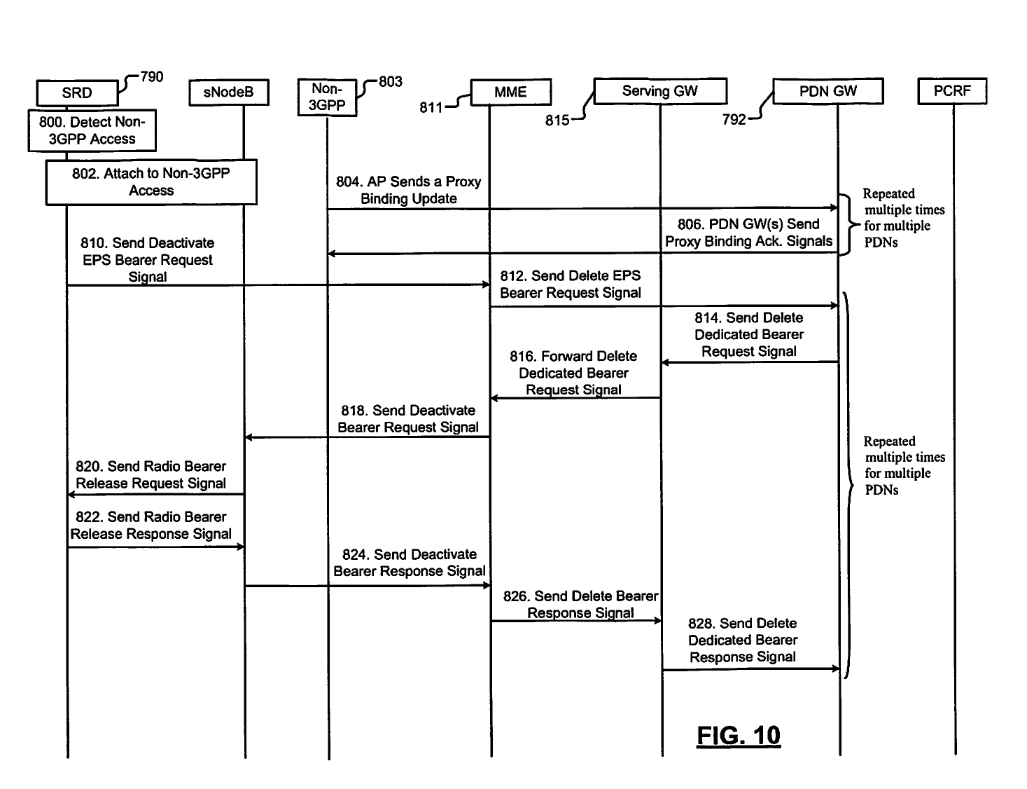

Referring now to FIG. 10, a message flow diagram illustrating a method of managing bearer deactivation when triggered by a SRD 790 and determined or initiated by a PDN GW 792. The SRD 790 triggers bearer deactivation. The PDN GW 792 determines whether to initiate bearer deactivation.

In step 800, the SRD 790 detects non-3GPP™ access. In step 802, the SRD 790 attaches to a non-3GPP™ network 803 associated with the non-3GPP™ access. The attachment may include a base station, such as an eNodeB. In step 804, the non-3GPP™ network 803 sets up a tunnel between the SRD 790 and the PDN GW 792 by sending a proxy binding update signal to the PDN GW 792. The non-3GPP™ network 803 updates the location of the SRDs using a network-based mobility protocol, such as PMIP.

In step 806, the PDN GW 792 confirms the tunnel setup by sending a proxy binding acknowledgement signal. Steps 804 and 806 may be repeated multiple times for setup of connectivity for the SRD 790 to multiple PDNs. Steps 804 and 806 may include host-based mobile IP signalling, when a host-based mobility protocol is used. The host-based signalling is between the SRD 790 and the PDN GW 792.

In step 810, the SRD 790 initiates a deactivation procedure for an EPS bearer by sending a deactivate EPS bearer request signal to a MME 811. The SRD 790 may send the deactivate EPS bearer request signal over a radio access network for one or more packet data networks.

The deactivate EPS bearer request signal may include a descriptor, such as an IP connectivity indicator that indicates whether IP connectivity with the PDN GW 792 should be released. As a result, IP connectivity for the SRD 790 with the PDN GW 792 may be maintained. The descriptor may also include one or more APNs, and associate an IP connectivity indicator to each APN to indicate which APNs are to be used and which APNs are not to be used.

In step 812, the MME 811 sends a delete EPS bearer request signal to a PDN GW 792 based on the deactivate EPS request signal from the SRD 790 to initiate a dedicated bearer deactivation procedure. The delete EPS bearer request signal may indicate to the PDN GW 792 not to release the IP connectivity for the SRD 790. The delete EPS bearer request signal may also include APN information as provided in step 810.

In step 814, the PDN GW 792 sends a delete dedicated bearer request message to a serving GW 815. The PDN GW 792 when initiating bearer deactivation generates the delete dedicated bearer request signal based on the delete EPS bearer request signal from the MME 811. In step 816, the serving GW 815 forwards the delete dedicated bearer request message to the MME 811. In step 818, the MME 811 sends a deactivate bearer request message to the eNodeB based on the delete dedicated bearer request message.

In step 820, the eNodeB sends a radio bearer release request message to the SRD 790 based on the deactivate bearer request message. In step 822, the SRD 790 removes UL TFTs corresponding to a released radio bearer. The SRD 790 then acknowledges release of the radio bearer by sending a radio bearer release response message to the eNodeB. Steps 820 and 822 may be performed when all bearers corresponding to the SRD 790 are released.

In step 824, the eNodeB acknowledges the bearer deactivation by sending a deactivate bearer response message to the MME 811. In step 826, the MME 811 acknowledges the bearer deactivation by sending a delete dedicated bearer response message to the serving GW 815. In step 828, the serving GW 815 acknowledges the bearer deactivation by sending a delete dedicated bearer response message to the PDN GW 792.

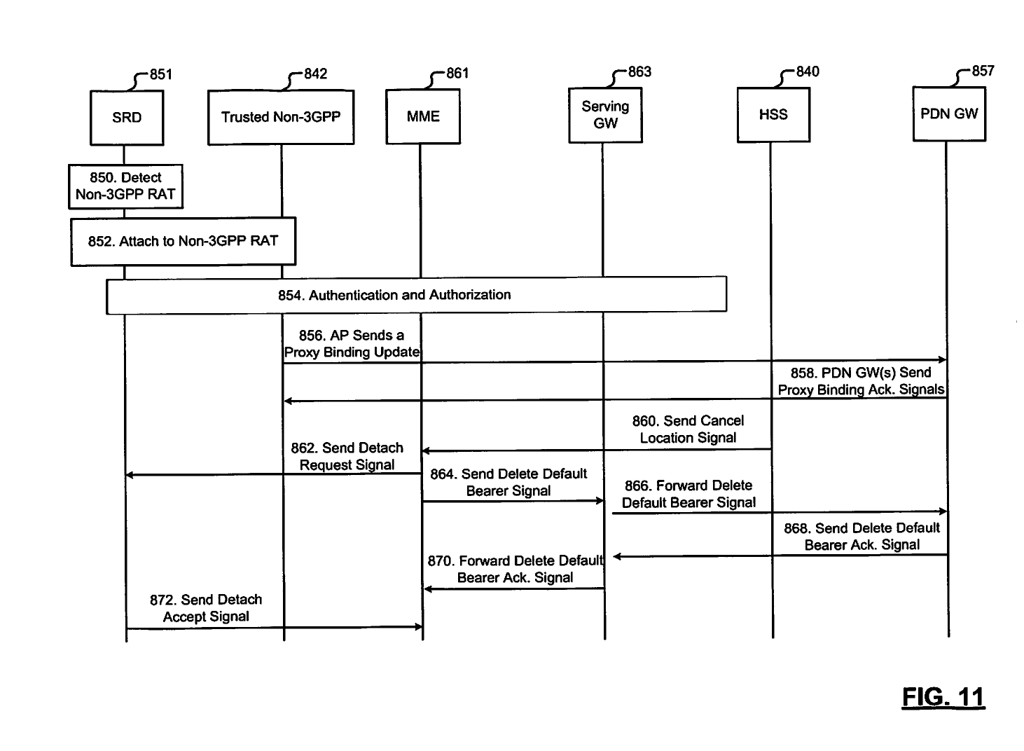

Referring now to FIG. 11, a message flow diagram illustrating a method of managing detachment initiated by a HSS 840 is shown. This method includes HSS-initiated detach as a result of a SRD attachment via a non-3GPP™ radio access technology (RAT). In one embodiment, it is assumed that a trusted non-3GPP™ network 842 uses a network-based protocol, such as PMIP, over a S5 link and a 3GPP™ network uses a GPRS tunneling protocol (GTP). Although the following steps are described primarily with respect to a trusted non-3GPP™ network, the steps may apply to other 3GPP™ and non-3GPP™ networks.

In step 850, a SRD 851 detects a non-3GPP™ RAT. In step 852, the SRD 851 attaches via the non-3GPP™ RAT. In step 854, the SRD 851 is authenticated and authorized by the HSS 840. The HSS 840 and/or an AAA server may have information that indicates that the SRD 851 is attached based on two access technologies. The HSS 840 and/or the AAA server may initiate a detachment procedure that detaches the SRD 851 from a RAN, such as a EUTRAN or a UTRAN in the 3GPP™ network. This is performed in step 860 and may be subject to local policies.

In step 856, a trusted non-3GPP™ GW 842 updates the location of a SRD tunnel using a network-based protocol. The trusted non-3GPP™ GW 842 generates a proxy binding update that is sent to a PDN GW 857. In step 858, the PDN GW 857 generates a proxy binding acknowledgement signal, which is sent to the trusted non-3GPP™ GW 842. Steps 856 and 858 may include host-based mobile IP signalling, when a host-based mobility protocol is used. The host-based signalling is between the SRD 851 and the PDN GW 857.

In step 860, the HSS 840, subject to the local policies, initiates the detach procedure from a RAN, such as a EUTRAN or a UTRAN in the 3GPP™ network. The HSS 840 sends a cancel location signal. The cancel location signal may include an indicator to avoid a MME 861 sending a request that will release the IP connectivity. The indicator may indicate that the SRD 851 is also attached to the trusted non-3GPP™ network 842. The indicator may include an IP connectivity entry that indicates whether IP connectivity should be maintained. In this described embodiment, the HSS 840 initially indicates that IP connectivity should be maintained rather than the SRD 851. Networks devices other than the HSS 840 may provide this indication, such as the MME 861, a serving GW 863, the PDN GW 857, etc.

In step 862, the MME 861 sends to the SRD 851 a detach request signal instructing the SRD 851 to detach from the RAN.

In step 864, the MME 861 sends a delete default bearer request signal to the serving GW 863 that may include a descriptor that indicates to the serving GW 863 not to release the IP connectivity for the SRD 851.

In step 866, the delete default bearer request signal is forwarded to the PDN GW 857. The delete default bearer request signal may include the descriptor of step 864. This indicates to the PDN GW 857 not to release the IP connectivity for the SRD 851.

In step 868, the PDN GW 857 responds to the delete default bearer request signal by sending a delete default bearer acknowledgement signal to the serving GW 863. In step 870, delete default bearer acknowledgement signal is forwarded to the MME 861. In step 872, the SRD 851 may send a detach accept signal to the MME 861 based on the delete default bearer acknowledgement signal.

In a multi-access mobile architecture, a SRD may have multiple corresponding sessions. The SRD may enable and disable sessions when active and travel and/or switch between different networks. The multiple sessions may be maintained in 3GPP™ networks and/or non-3GPP™ networks. In order to for the sessions to be maintained bearer setup for each session is provided and tracked. For the tracking of the sessions to be maintained by the 3GPP™ and/or non-3GPP™ networks, other than by the SRD, such as by a PDN GW, a serving GW, a MME, etc., can be complicated.

Also, tunneling over 3GPP™ networks may be different than over non-3GPP™ networks, thus if a network device other than a SRD performs a detachment or deactivation procedure, a SRD may be locked into a certain procedure. The network device performing the detachment or deactivation procedure would need to have logic that correlates between 3GPP™ and non-3GPP™ procedures. The logic would need to be maintained. This logic would not need to be maintained if the SRD controls the detachment or deactivation procedure.

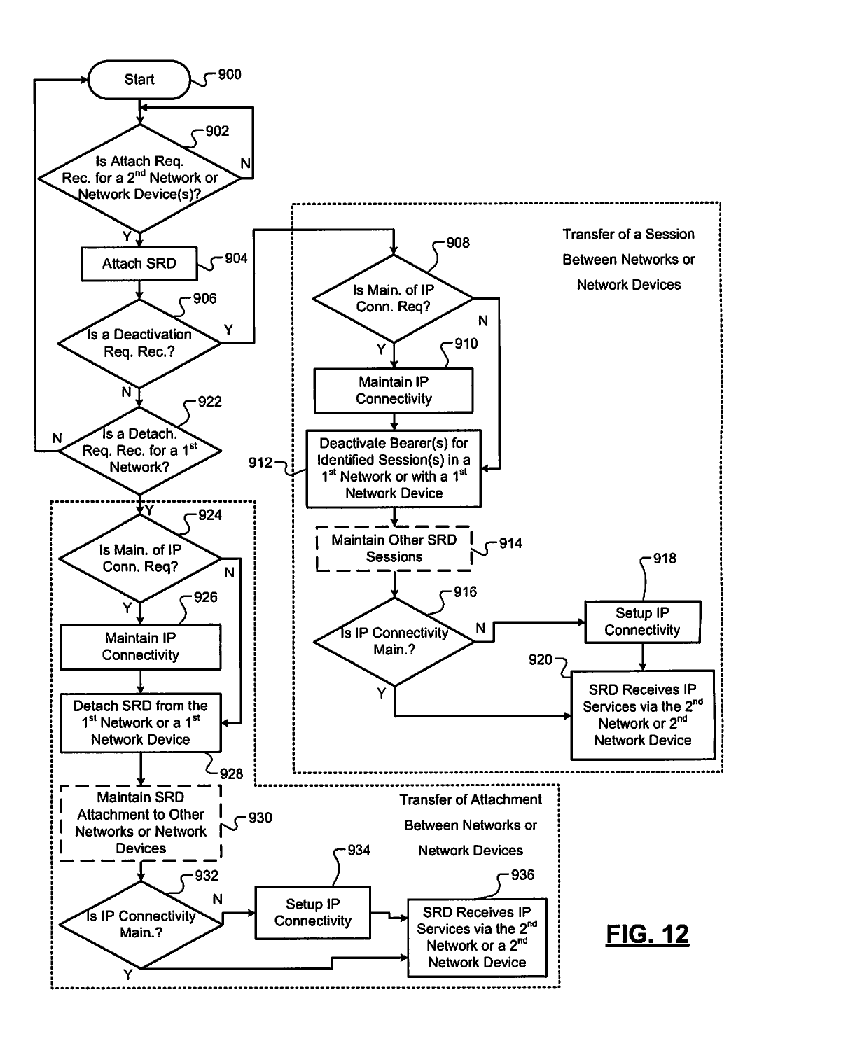

Since a SRD is aware of currently enabled sessions and of sessions that are to be enabled in the future, the SRD may initiate detachment and/or deactivation, as well as provide IP connectivity request signals for the maintenance of IP connectivity. The IP connectivity may be maintained when detaching from a first network and/or network device and attaching to a second network or network device. The IP connectivity may also be maintained when deactivating a current session with a first network and/or network device and activating the current session or a new session with a second network or network device. The detachment/attachment and deactivation/activation between networks and network devices may be referred to as an attachment transfer or a session transfer, which may occur between 3GPP™ and non-3GPP™ networks and network devices. FIG. 12 provides examples of performing the described transfers.

Referring now to FIG. 12, a logic flow diagram illustrating a method of performing attachment and activation transfer is shown. An SRD may have multiple sessions active at any moment in time. The sessions may be with the same network and/or network device(s) or may be with different networks and/or network device(s). The method may begin at step 700. In the following steps, the term control may refer to logic of a SRD or other network device, such as logic of a MME, a RAN, an AP, a serving GW, a PDN GW, a HSS, etc.

In step 902, when an attachment request is received for a second network or network device(s) other than by a SRD, step 904 is performed, otherwise step 902 is repeated. The SRD may attach to a second network that is different than the first network when transferring a session. The SRD may attach to a different network device or group of network devices within the first network when transferring a session. Additional sessions with the second network or network device(s) may be activated. In step 904, the SRD is attached to the second network or network device(s). Attachment may be performed, for example, as described in TS 23.401 and may include authorization and authentication of the SRD, deletion of previous bearers associated with the SRD, generation of updated, default, and/or dedicated bearers, etc.

In step 906, when a deactivation request is received, control proceeds to step 908, otherwise control proceeds to step 922. The deactivation request may be generated by the SRD or by some other network device, such as a RAN, MME, serving GW, PDN GW, etc. The deactivation request may identify one or more sessions to deactivate and/or transfer. The SRD may generate an IP descriptor, which may be provided to an MME, a PDN GW, or other network device via an access point, a radio access network, etc.

In step 908, when maintenance of IP connectivity is requested, control proceeds to step 910, otherwise control proceeds to step 912. In step 910, IP connectivity for the SRD is maintained. For example only, a current PDN GW, a new or subsequent PDN GW, or a HSS may maintain IP connectivity active or in a permitted state for the SRD.

In step 912, one or more current bearer(s) for the sessions to be deactivated or transferred are deactivated for a first network or network device(s). Basic connectivity and/or IP connectivity may be maintained. When transferring between PDN GWs of the same network, a deactivation may correspond to a session with a first PDN GW. In step 914, other sessions of the SRD may be maintained in an active state. The other sessions may be in the first network, the second network, or in some other network.

In step 916, when IP connectivity is not maintained, control proceeds to step 918, otherwise control proceeds to step 920.

In step 918, IP connectivity is setup for the SRD. When basic connectivity is maintained, a local network may establish the IP connectivity without use of or communication with a home network. In step 920, the SRD receives IP services via the second network or network device(s). The SRD maintains sessions in the first network. The SRD may receive services from the first network while receiving services from the second network.

In step 922, when a detachment request is received, control proceeds to step 924, otherwise control returns to step 900. The detachment request may be generated by the SRD, a MME, a RAN, a HSS, a serving GW, a PDN GW, etc.

In step 924, when a maintenance request of IP connectivity is received, control proceeds to step 926, otherwise control proceeds to step 928. The maintenance request may be generated by the SRD, or by some other network device. The maintenance request may include an IP descriptor and may be provided to a MME, a RAN, a serving GW, a PDN GW, etc.

In step 926, IP connectivity is maintained for the SRD. For example only, a current PDN GW, a new or subsequent PDN GW, or a HSS may maintain IP connectivity active or in a permitted state for the SRD. In step 928, the SRD is detached from a first network or network device(s). This may include deactivation of one or more bearer(s) for one or more session(s) between the SRD and the first network or network device(s). The detachment may be a complete detachment from the first network in which the SRD may not receive any services from the first network after detachment.

In step 930, attachment of the SRD to networks or network devices other than the first network or network device(s) may be maintained.

In step 932, when IP connectivity is not maintained, control proceeds to step 934, otherwise control proceeds to step 936 to setup IP connectivity. In step 934, IP connectivity is setup for the SRD. When basic connectivity is maintained, a local network may establish the IP connectivity without use of or communication with a home network. In step 936, the SRD receives IP services via the second network or network device(s).

The above-described steps in the above-described Figures are meant to be illustrative examples; the steps may be performed sequentially, synchronously, simultaneously, continuously, during overlapping time periods or in a different order depending upon the application. As an example, the attachment described in the methods of FIGS. 8-11 may be performed before, during, or after the detachment and/or the deactivation described in the same methods. Also, the above-described methods may be applied to a network system that supports multiple PDNs through use of multiple PDN GWs.

Referring now to FIG. 13, an example IP descriptor 950 is shown. The IP descriptor 950 indicates which bearers to deactivate, which bearers to activate, whether IP connectivity is to be maintained, which PDNs and/or PDN GWs to remove or add in association with the SRD, etc. The IP descriptor 950 may provide policy and/or packet information, such as packet protocols indicating how packets are to be handled, The IP descriptor 950 may provide access point names (APNs) for the PDNs and/or PDN GWs. The IP descriptor 950 may, for example, include bearer ACT and bearer DEACT bits 952, 954, IP CONN bits 956, PDN GW ADD bits 958, PDN GW REMOVE bits 960, POLICY/PACK INFO bits 962, and an APN 964, corresponding to the described indications.

An SRD may provide an indication of connectivity domain and IP service(s) preference by providing the APN 964. The APN 964 may include a PDN ID 966, a PDN GW ID 968, IP service IDs 970 and/or a network system ID 972. The APN 964 may also include a domain name that identifies an operator, such as AT&T™ or T-mobile™. The network system identifier may indicate relationship of the APN 964 with a network system, such as a 3GPP™ network system. Each of the stated identifiers may be one or more bits in length.

Referring now to FIGS. 14 and 15, example FQDNs 970, 972 are respectively shown. The FQDN 970 includes a PDN ID 974, a PDN GW ID 975, IP service IDs 976, and/or a VPLMN identifier 977. The FQDN 972 includes a PDN ID 980, a PDN GW ID 981, IP service IDs 982, and/or a HPLMN identifier 983.

The embodiments disclosed herein provide system architectures that support both host-based IP mobility management (CMIP) and network-based mobility management (PMIP). The system architectures support CMIP-capable SRDs, PMIP-capable SRDs, and CIMP/PMIP-capable SRDs. Thus, system architectures apply to networks that support PMIP and/or CMIP based handovers.

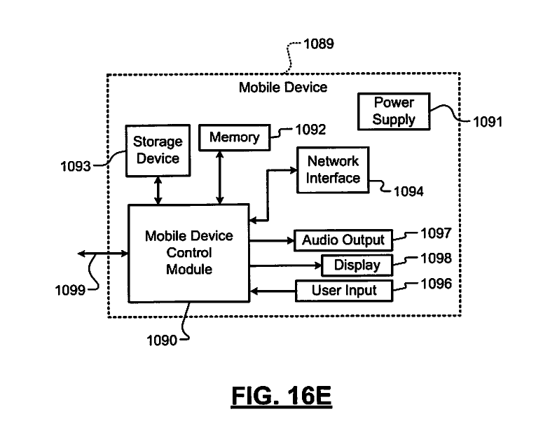

Referring now to FIGS. 16A-16E, various exemplary implementations incorporating the teachings of the present disclosure are shown.

Referring now to FIG. 16A, the teachings of the disclosure can be implemented in a network interface 1043 of a high definition television (HDTV) 1037. The HDTV 1037 includes an HDP/control module 1038, a display 1039, a power supply 1040, memory 1041, a storage device 1042, the network interface 1043, and an external interface 1045. If the network interface 1043 includes a wireless local area network interface, an antenna (not shown) may be included.

The HDTV 1037 can receive input signals from the network interface 1043 and/or the external interface 1045, which can send and receive data via cable, broadband Internet, and/or satellite. The HDTV control module 1038 may process the input signals, including encoding, decoding, filtering, and/or formatting, and generate output signals. The output signals may be communicated to one or more of the display 1039, memory 1041, the storage device 1042, the network interface 1043, and the external interface 1045.

Memory 1041 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1042 may include an optical storage drive, such as a DVD drive, and/or a hard disk drive (HDD). The HDTV control module 1038 communicates externally via the network interface 1043 and/or the external interface 1045. The power supply 1040 provides power to the components of the HDTV 1037.

Referring now to FIG. 16B, the teachings of the disclosure may be implemented in a network interface 1052 of a vehicle 1046. The vehicle 1046 may include a vehicle control system 1047, a power supply 1048, memory 1049, a storage device 1050, and the network interface 1052. If the network interface 1052 includes a wireless local area network interface, an antenna (not shown) may be included. The vehicle control system 1047 may be a powertrain control system, a body control system, an entertainment control system, an anti-lock braking system (ABS), a navigation system, a telematics system, a lane departure system, an adaptive cruise control system, etc.

The vehicle control system 1047 may communicate with one or more sensors 1054 and generate one or more output signals 1056. The sensors 1054 may include temperature sensors, acceleration sensors, pressure sensors, rotational sensors, airflow sensors, etc. The output signals 1056 may control engine operating parameters, transmission operating parameters, suspension parameters, braking parameters, etc.

The power supply 1048 provides power to the components of the vehicle 1046. The vehicle control system 1047 may store data in memory 1049 and/or the storage device 1050. Memory 1049 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1050 may include an optical storage drive, such as a DVD drive, and/or a hard disk drive (HDD). The vehicle control system 1047 may communicate externally using the network interface 1052.

Referring now to FIG. 16C, the teachings of the disclosure can be implemented in a network interface 1068 of a cellular phone 1058. The cellular phone 1058 includes a phone control module 1060, a power supply 1062, memory 1064, a storage device 1066, and a cellular network interface 1067. The cellular phone 1058 may include the network interface 1068, a microphone 1070, an audio output 1072 such as a speaker and/or output jack, a display 1074, and a user input device 1076 such as a keypad and/or pointing device. If the network interface 1068 includes a wireless local area network interface, an antenna (not shown) may be included.

The phone control module 1060 may receive input signals from the cellular network interface 1067, the network interface 1068, the microphone 1070, and/or the user input device 1076. The phone control module 1060 may process signals, including encoding, decoding, filtering, and/or formatting, and generate output signals. The output signals may be communicated to one or more of memory 1064, the storage device 1066, the cellular network interface 1067, the network interface 1068, and the audio output 1072.

Memory 1064 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1066 may include an optical storage drive, such as a DVD drive, and/or a hard disk drive (HDD). The power supply 1062 provides power to the components of the cellular phone 1058.

Referring now to FIG. 16D, the teachings of the disclosure can be implemented in a network interface 1085 of a set top box 1078. The set top box 1078 includes a set top control module 1080, a display 1081, a power supply 1082, memory 1083, a storage device 1084, and the network interface 1085. If the network interface 1085 includes a wireless local area network interface, an antenna (not shown) may be included.

The set top control module 1080 may receive input signals from the network interface 1085 and an external interface 1087, which can send and receive data via cable, broadband Internet, and/or satellite. The set top control module 1080 may process signals, including encoding, decoding, filtering, and/or formatting, and generate output signals. The output signals may include audio and/or video signals in standard and/or high definition formats. The output signals may be communicated to the network interface 1085 and/or to the display 1081. The display 1081 may include a television, a projector, and/or a monitor.

The power supply 1082 provides power to the components of the set top box 1078. Memory 1083 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1084 may include an optical storage drive, such as a DVD drive, and/or a hard disk drive (HDD).

Referring now to FIG. 16E, the teachings of the disclosure can be implemented in a network interface 1094 of a mobile device 1089. The mobile device 1089 may include a mobile device control module 1090, a power supply 1091, memory 1092, a storage device 1093, the network interface 1094, and an external interface 1099. If the network interface 1094 includes a wireless local area network interface, an antenna (not shown) may be included.

The mobile device control module 1090 may receive input signals from the network interface 1094 and/or the external interface 1099. The external interface 1099 may include USB, infrared, and/or Ethernet. The input signals may include compressed audio and/or video, and may be compliant with the MP3 format. Additionally, the mobile device control module 1090 may receive input from a user input 1096 such as a keypad, touchpad, or individual buttons. The mobile device control module 1090 may process input signals, including encoding, decoding, filtering, and/or formatting, and generate output signals.

The mobile device control module 1090 may output audio signals to an audio output 1097 and video signals to a display 1098. The audio output 1097 may include a speaker and/or an output jack. The display 1098 may present a graphical user interface, which may include menus, icons, etc. The power supply 1091 provides power to the components of the mobile device 1089. Memory 1092 may include random access memory (RAM) and/or nonvolatile memory.

Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1093 may include an optical storage drive, such as a DVD drive, and/or a hard disk drive (HDD). The mobile device may include a personal digital assistant, a media player, a laptop computer, a gaming console, or other mobile computing device.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A network device comprising:
an Internet protocol (IP) connectivity generator that generates an IP connectivity indicator, the IP connectivity indicator indicating IP connectivity for a service request device (SRD);
a transmit module that transmits said IP connectivity indicator to a remote network device before at least one of:
detachment of said SRD; and
deactivation of a bearer corresponding to a first session and a tunnel between said SRD and said remote network device; and
a control module that facilitates said at least one of detachment of said SRD and deactivation of said bearer while maintaining IP connectivity corresponding to at least one of:
attachment of said SRD; and
activation of a second session of said SRD based on said IP connectivity indicator.

2. The network device of claim 1, wherein said bearer comprises a set of addresses corresponding to said first session and associated with communication between said SRD and a packet data network.

3. The network device of claim 1, wherein said control module facilitates said at least one of attachment of said SRD and activation of said second session based on maintenance of said IP connectivity.

4. The network device of claim 1, wherein said control module initiates said at least one of attachment of said SRD and activation of said second session.

5. The network device of claim 1, wherein said detachment includes detachment from a first network, and
wherein said control module facilitates attachment of said SRD to a second network.

6. The network device of claim 5, wherein said first network includes at least one of a radio access network and a servicing general packet radio service support node.

7. The network device of claim 5, wherein said first network includes a cellular network and said second network includes wireless local area network.

8. The network device of claim 1, wherein said detachment includes detachment from a first network device of a network, and
wherein said control module attaches said SRD to a second network device of said network.

9. The network device of claim 1, wherein said first session and said second session are with at least one of the same network and gateway.

10. The network device of claim 1, wherein said first session and said second session are with at least one of the same packet data network and packet data network gateway.

11. The network device of claim 1, wherein said first session includes communication via a tunnel of a first network and said second session includes communication via a tunnel of a second network that is different than said first network.

12. The network device of claim 11, wherein said first network includes a cellular network and said second network includes wireless local area network.

13. The network device of claim 1, wherein said first session includes communication via a first tunnel of a first network and said second session includes communication via a second tunnel between said first network and a second network that is different than said first network.

14. The network device of claim 1, wherein said SRD includes the network device.

15. The network device of claim 1, wherein IP connectivity of said SRD is maintained during said at least one of detachment of said SRD and deactivation of said bearer based on said IP connectivity indicator.

16. The network device of claim 15, wherein said IP connectivity is maintained between said SRD and a packet data network.

17. The network device of claim 1, wherein connectivity of said SRD is maintained with a network and said IP connectivity corresponding to said at least one of attachment of said SRD and activation of said second session is not maintained when said bearer is deactivated based on said IP connectivity indicator.

18. The network device of claim 1, wherein said SRD includes the network device, and
wherein said control module at least one of initiates and triggers said at least one of detachment of said SRD and deactivation of said bearer.

19. The network device of claim 18, wherein said control module triggers said at least one of detachment of said SRD and deactivation of said bearer by generating a deactivate bearer request signal that includes said IP connectivity indicator, and
wherein said remote network device initiates said at least one of detachment of said SRD and deactivation of said bearer by generating a delete dedicated bearer request signal based on said deactivate bearer request signal.

20. The network device of claim 1, further comprising a receive module,
wherein said transmit module transmits a detach request signal including said IP connectivity indicator to said remote network device, and
wherein said receive module receives a detach accept signal based on said detach request signal.

21. The network device of claim 1, further comprising a receive module,
wherein said transmit module transmits a deactivate bearer request signal including said IP connectivity indicator to said remote network device, and
wherein said receive module receives a deactivate accept signal based on said deactivate bearer request signal.

22. The network device of claim 1, further comprising a receive module,
wherein said transmit module transmits a deactivate request signal including said IP connectivity indicator to said remote network device,
wherein said receive module receives a bearer release request signal based on said deactivate request signal, and
wherein said transmit module transmits to said remote network device a bearer release response signal based on said bearer release request signal.

23. The network device of claim 1, further comprising a receive module,
wherein said control module generates a deactivate bearer request signal that includes said IP connectivity indicator,
wherein said receive module receives a bearer release request signal from said remote network device based on said deactivate bearer request signal, and
wherein said control module removes uplink traffic flow templates corresponding to said bearer.

24. The network device of claim 1, further comprising a receive module,
wherein said transmit module transmits a cancel location signal including said IP connectivity indicator to said remote network device, and
wherein said receive module receives a delete bearer signal based on said cancel location signal.

25. A system comprising the network device of claim 1, wherein:
said control module initiates said at least one of detachment of said SRD and deactivation of said bearer; and
said system comprises one of a mobility management entity, a serving gateway, a PDN gateway, or a server.

26. A network comprising the network device of claim 1, and further comprising said remote network device,
wherein said remote network device receives said IP connectivity indicator and proceeds to at least one of detach said SRD and deactivate said bearer while maintaining IP connectivity of said SRD based on said IP connectivity indicator.

27. A method of operating a network device comprising:
generating an Internet protocol (IP) connectivity indicator that indicates IP connectivity for a service request device (SRD);
transmitting said IP connectivity indicator to a remote network device before at least one of:
detachment of said SRD; and
deactivation of a bearer corresponding to a first session and a tunnel between said SRD and said remote network device; and
facilitating said at least one of detachment of said SRD and deactivation of said bearer while maintaining IP connectivity corresponding to at least one of:
attachment of said SRD; and
activation of a second session of said SRD based on said IP connectivity indicator.

28. The method of claim 27, wherein said bearer comprises a set of addresses corresponding to said first session and associated with communication between said SRD and a packet data network.

29. The method of claim 27, further comprising facilitating said at least one of attachment of said SRD and activation of said second session based on maintenance of said IP connectivity.

30. The method of claim 27, further comprising initiating said at least one of attachment of said SRD and activation of said second session.

31. The method of claim 27, further comprising facilitating attachment of said SRD to a second network,
wherein said detachment includes detachment from a first network.

32. The method of claim 31, wherein said first network includes at least one of a radio access network and a servicing general packet radio service support node.

33. The method of claim 31, wherein said first network includes a cellular network and said second network includes wireless local area network.

34. The method of claim 27, further comprising attaching said SRD to a second network device of said network,
wherein said detachment includes detachment from a first network device of a network.

35. The method of claim 27, wherein said first session and said second session are with at least one of the same network and gateway.

36. The method of claim 27, wherein said first session and said second session are with at least one of the same packet data network and packet data network gateway.

37. The method of claim 27, wherein said first session includes communication via a tunnel of a first network and said second session includes communication via a tunnel of a second network that is different than said first network.

38. The method of claim 37, wherein said first network includes a cellular network and said second network includes wireless local area network.

39. The method of claim 27, wherein said first session includes communication via a first tunnel of a first network and said second session includes communication via a second tunnel between said first network and a second network that is different than said first network.

40. The method of claim 27, wherein said SRD includes the network device.

41. The method of claim 27, further comprising maintaining IP connectivity of said SRD during said at least one of detachment of said SRD and deactivation of said bearer based on said IP connectivity indicator.

42. The method of claim 41, comprising maintaining said IP connectivity between said SRD and a packet data network.

43. The method of claim 27, further comprising maintaining connectivity of said SRD with a network and not maintaining said IP connectivity corresponding to said at least one of attachment of said SRD and activation of said second session when said bearer is deactivated based on said IP connectivity indicator.

44. The method of claim 27, further comprising at least one of initiating and triggering said at least one of detachment of said SRD and deactivation of said bearer,
wherein said SRD includes the network device.

45. The method of claim 44, further comprising:
triggering said at least one of detachment of said SRD and deactivation of said bearer by generating a deactivate bearer request signal that includes said IP connectivity indicator; and
initiating said at least one of detachment of said SRD and deactivation of said bearer via said remote network device by generating a delete dedicated bearer request signal based on said deactivate bearer request signal.

46. The method of claim 27, further comprising:
transmitting a detach request signal including said IP connectivity indicator to said remote network device; and
receiving a detach accept signal based on said detach request signal.

47. The method of claim 27, further comprising:
transmitting a deactivate bearer request signal including said IP connectivity indicator to said remote network device; and
receiving a deactivate accept signal based on said deactivate bearer request signal.

48. The method of claim 27, further comprising:
transmitting a deactivate request signal including said IP connectivity indicator to said remote network device;
receiving a bearer release request signal based on said deactivate request signal; and
transmitting to said remote network device a bearer release response signal based on said bearer release request signal.

49. The method of claim 27, further comprising:
generating a deactivate bearer request signal that includes said IP connectivity indicator;
receiving a bearer release request signal from said remote network device based on said deactivate bearer request signal; and
removing uplink traffic flow templates corresponding to said bearer.

50. The method of claim 27, further comprising:
transmitting a cancel location signal including said IP connectivity indicator to said remote network device; and
receiving a delete bearer signal based on said cancel location signal.

51. The method of claim 27, further comprising receiving said IP connectivity indicator via said remote network device and proceeding to at least one of detaching said SRD and deactivating said bearer while maintaining IP connectivity of said SRD based on said IP connectivity indicator.
